(19) United States
(12) Patent Application Publication
(10) Pub. No.: US 2016/0342614 A1
(43) Pub. Date: Nov. 24, 2016

(54) METHOD FOR TRANSFERRING DATA ITEMS IN AN ELECTRONIC DEVICE

(71) Applicant: SAMSUNG ELECTRONICS CO., LTD., Suwon-si (KR)

(72) Inventors: Pulkit AGRAWAL, Aligarh (IN); Tarun SHARMA, Punjab (IN); Lovlesh MALIK, Haryana (IN)

(73) Assignee: SAMSUNG ELECTRONICS CO., LTD., Suwon-si (KR)

(21) Appl. No.: 15/159,082

(22) Filed: May 19, 2016

(30) Foreign Application Priority Data
May 19, 2015 (IN) 1411/DEL/2015
May 19, 2016 (KR) 10-2016-0061623

(51) Int. Cl. G06F 17/30; G06F 3/0482; G06F 3/0484; G06F 3/0488

(52) U.S. Cl. CPC G06F 17/30126; G06F 3/0488; G06F 3/0482; G06F 3/04842

(57) ABSTRACT

A method for transferring data items in an electronic device is provided. The method includes associating a function and a data item with an identifier based on a user action performed in a source location, and performing the function to transfer the data item from the source location to a target location based on the user action performed on the identifier in the target location.

### CROSS-REFERENCE TO RELATED APPLICATION(S)

This application claims priority from Indian Patent Application No. 1411/DEL/2015, filed on May 19, 2015 in the Indian Patent Office, and Korean patent application No. 10-2016-0061623 filed on May 19, 2016, in the Korean Intellectual Property Office the entire disclosure of which is hereby incorporated by reference.

### FIELD

Methods, apparatuses, devices, and articles of manufacture consistent with the present disclosure relate to electronic devices and, more particularly, to a technology for transferring one or more data items from the same or multiple source locations.

### BACKGROUND

Portable electronic devices such as smart phones, personal digital assistants (PDAs), and tablets have become popular and ubiquitous. The memory in the portable electronic devices has been growing at a rampant rate. As a result, a user has an advantage of keeping more and more files in a file system of the portable electronic device. But with the ever increasing number of files in the device, the management of these files poses certain challenges. For example, if all the files are kept in a single directory (e.g., more simply and unorganized), it becomes more likely that a user will become confused, resulting in more effort (e.g., in terms of time and number of clicks) in reaching a desired file.

Further, transferring (e.g., copying or moving) files stored in the memory of the portable electronic device from one location to another location helps in managing the files in the electronic device. In a case in which multiple files from multiple source locations are to be transferred to one or more target locations, related art methods and systems become cumbersome and time consuming.

For example, in a scenario in which the user needs to copy multiple files from a first source location and multiple files from a second source location to a target location, the user may access the first source location and select files to be copied from the first source location by performing a gesture. After selecting the files, the user may access a target location to copy the selected files to the target location. Further, the user may access the second source location to select the files to be copied and, after selecting the files, the user again accesses the target location to copy the selected files to the target location. Thus, there is a disadvantage in that the number of actions performed by the user to transfer multiple files from the multiple source locations to the target location increases.

### SUMMARY

According to an aspect of an exemplary embodiment, there is provided a method for transferring data items in an electronic device, the method comprising associating a function and at least one data item with an identifier based on a user action performed in a source location; and performing the function to transfer the at least one data item from the source location to a target location based on the user action performed on the identifier in the target location.

The user action is performed in the source location and the target location, and the user action comprises at least one of a pattern of gestures or a type of gesture to be performed on at least one of the identifier, the at least one data item and the function.

According to another aspect of an exemplary embodiment, there is provided a method for transferring data items in an electronic device, the method comprising associating at least one data item with an identifier based on a user action performed in a source location; associating the identifier with a function based on the user action performed in a target location; and performing the function to transfer the at least one data item from the source location to the target location.

The user action is performed in the source location and the target location, and the user action comprises at least one of a pattern of gestures or a type of gesture to be performed on at least one of the identifier, the at least one data item and the function.

According to another aspect of an exemplary embodiment, there is provided a method for transferring data items in an electronic device, the method comprising associating a first data item and a first function with an identifier based on a user action performed in a source location; associating a second data item and a second function with the identifier based on the user action performed in the source location; and performing the first function and the second function to transfer the first data item and the second data item from the source location to a target location based on the user action performed on the identifier in the target location.

The user action is performed in the source action and the target location, and the user action comprises at least one of a pattern of gestures or a type of gesture to be performed on at least one of the identifier, the first data item, the second data item, the first function, and the second function.

According to another aspect of an exemplary embodiment, there is provided a method for transferring data items in an electronic device, the method comprising associating a first data item and a first function with an identifier based on a user action performed in a first source location; associating a second data item and a second function with the identifier based on the user action performed in a second source location; and performing the first function and the second function to transfer the first data item from the first source location and the second data item from the second source location to a target location based on the user action performed on the identifier in the target location.

The user action is performed in the first source location, the second source location and the target location, and the user action comprises at least one of a pattern of gestures or a type of gesture to be performed on at least one of the identifier, the first function, the second function, the first data item and the second data item.

According to another aspect of an exemplary embodiment, there is provided an electronic device for transferring data items, the electronic device comprising at least one microprocessor configured to associate a function and at least one data item with an identifier based on a user action performed in a source location; and perform the function to transfer the at least one data item from the source location to a target location based on the user action performed on the identifier in the target location.

The user action is performed in the source location and the target location, and the user action comprises at least one of a pattern of gestures or a type of gesture to be performed on at least one of the identifier, the function and the at least one data item.

According to another aspect of an exemplary embodiment, there is provided an electronic device for transferring data items, the electronic device comprising at least one microprocessor configured to associate at least one data item with an identifier based on a user action performed in a source location; associate the identifier with a function based on the user action performed in a target location; and perform the function to transfer the first data item from the source location to the target location.

The user action is performed in the source location and the target location, and the user action comprises at least one of a pattern of gestures or a type of gesture to be performed on at least one of the identifier, the function and the at least one data item.

According to another aspect of an exemplary embodiment, there is provided an electronic device for transferring data items, the electronic device comprising at least one microprocessor configured to associate a first data item and a first function with an identifier based on a user action performed in a source location; associate a second data item and a second function with the identifier based on the user action performed in the source location; and perform the first function and the second function to transfer the first data item and the second data item from the source location to a target location based on the user action performed on the identifier in the target location.

The user action is performed in the first source location, the second source location and the target location, and the user action comprises at least one of a pattern of gestures or a type of gesture to be performed on at least one of the identifier, the first function, the second function, the first data item and the second data item.

According to another aspect of an exemplary embodiment, there is provided an electronic device for transferring data items, the electronic device comprising at least one microprocessor configured to associate a first data item and a first function with an identifier based on a user action performed in a first source location; associate a second data item and a second function with the identifier based on the user action performed in a second source location; and perform the first function and the second function to transfer the first data item from the first source location and the second data item from the second source location to a target location based on the user action performed on the identifier in the target location.

The user action is performed in the first source location, the second source location and the target location, and the user action comprises at least one of a pattern of gestures or a type of gesture to be performed on at least one of the identifier, the first function, the second function, the first data item and the second data item.

According to another aspect of an exemplary embodiment, there is provided a computer program product comprising computer executable program code recorded on a computer readable non-transitory storage medium, wherein the computer executable program code when executed by a computer causes functions including associating a function and at least one data item with an identifier based on a user action performed in a source location; and performing the function to transfer the at least one data item from the source location to a target location based on the user action performed on the identifier in the target location.

According to another aspect of an exemplary embodiment, there is provided a computer program product comprising computer executable program code recorded on a computer readable non-transitory storage medium, wherein the computer executable program code when executed by a computer causes functions including associating at least one data item with an identifier based on a user action performed in a source location; associating the identifier with a function based on the user action performed in a target location; and performing the function to transfer the first data item from the source location to the target location.

According to another aspect of an exemplary embodiment, there is provided a computer program product comprising computer executable program code recorded on a computer readable non-transitory storage medium, wherein the computer executable program code when executed by a computer causes functions including associating a first data item and a first function with an identifier based on a user action performed in a source location; associating a second data item and a second function with the identifier based on the user action performed in the source location; and performing the first function and the second function to transfer the first data item and the second data item from the source location to a target location based on the user action performed on the identifier in the target location.

According to another aspect of an exemplary embodiment, there is provided a computer program product comprising computer executable program code recorded on a computer readable non-transitory storage medium, wherein the computer executable program code when executed by a computer causes functions including associating a first data item and a first function with an identifier based on a user action performed in a first source location; associating a second data item and a second function with the identifier based on the user action performed in a second source location; and performing the first function and the second function to transfer the first data item from the first source location and the second data item from the second source location to a target location based on the user action performed on the identifier in the target location.

### BRIEF DESCRIPTION OF FIGURES

Various exemplary embodiments are illustrated in the accompanying drawings, throughout which like reference letters indicate corresponding parts in the various figures, and will be better understood from the following description with reference to the drawings, in which:

FIG. 1 illustrates an electronic device for transferring one or more data items from a same source location or multiple source locations to a target location, according to exemplary embodiments;

FIG. 2 illustrates various components of the electronic device for transferring one or more data items from a same source location or multiple source locations to a target location, according to exemplary embodiments;

FIG. 3 is a flow diagram illustrating a method for transferring one or more data items from a source location to a target location in the electronic device, according to exemplary embodiments;

FIG. 4 is another flow diagram illustrating a method for transferring one or more data items from a source location to a target location in the electronic device, according to exemplary embodiments;

FIG. 5 is another flow diagram illustrating a method for transferring a first data item by performing a first function and a second data item by performing a second function from a source location to the target location in the electronic device, according to exemplary embodiments;

FIG. 6 is another flow diagram illustrating a method for transferring the first data item from a first source location and a second data item from a second source location to a target location in the electronic device, according to exemplary embodiments;

FIGS. 7A and 7B are another flow diagram illustrating a method for transferring one or more data items from a source location to a target location in the electronic device, according to exemplary embodiments;

FIG. 8 illustrates a translation table for mapping a number input to a specific color output for transferring data items in the electronic device, according to exemplary embodiments;

FIGS. 9A to 9D illustrate an example of transferring one or more data items from the source location to the target location in the electronic device, according to exemplary embodiments;

FIGS. 10A to 10D illustrate an example of transferring one or more data items from the source location to the target location in the electronic device, according to exemplary embodiments;

FIGS. 11A to 11D illustrate an example of transferring the first data item by performing the first function and the second data item by performing the second function in the electronic device, according to exemplary embodiments;

FIGS. 12A to 12F illustrate an example of transferring the first data item from the first source location by performing the first function and the second data item from the second source location by performing the second function in the electronic device, according to exemplary embodiments;

FIGS. 13A to 13G illustrate another example of transferring the first data item from a first source location and the second data item from a second source location to the target location in the electronic device, according to exemplary embodiments;

FIGS. 14A to 14E illustrate an example of transferring or sharing one or more data items in the electronic device, according to exemplary embodiments;

FIGS. 15A to 15D illustrate an example of transferring the first data item by performing the first function and the second data item by performing the second function from the source location to the target location in the electronic device, according to exemplary embodiments; and

FIG. 16 illustrates a computing environment implementing the method for transferring one or more data items from a same source location or multiple source locations to a target location in the electronic device, according to exemplary embodiments.

### DETAILED DESCRIPTION

Various exemplary embodiments herein and the various features and advantageous details thereof are explained more fully with reference to the non-limiting exemplary embodiments that are illustrated in the accompanying drawings and detailed in the following description. Descriptions of well-known components and processing techniques are omitted so as to not unnecessarily obscure the exemplary embodiments herein. Also, the various exemplary embodiments described herein are not necessarily mutually exclusive, as some exemplary embodiments may be combined with one or more other exemplary embodiments to form new embodiments. The term “or” as used herein, refers to a non-exclusive “or”, unless otherwise indicated. The examples used herein are intended merely to facilitate understanding of ways in which the exemplary embodiments herein may be practiced and to further enable those skilled in the art to practice the exemplary embodiments herein. Accordingly, the examples should not be construed as limiting the scope of the exemplary embodiments herein.

Exemplary embodiments herein relate to a method for transferring data items in an electronic device. The method includes associating a function and at least one data item with an identifier based on a user action performed in a source location. Further, the method includes performing the function to transfer the first data item from the source location to a target location based on the user action performed on the identifier by the user in the target location.

Other exemplary embodiments herein relate to a method for transferring data items in an electronic device. The method includes associating at least one data item with an identifier based on a user action performed in a source location. Further, the method includes associating the identifier with a function based on the user action performed by the user in a target location. Further, the method includes performing the function to transfer the at least one data item from the source location to the target location.

Still other exemplary embodiments herein relate to a method for transferring data items in an electronic device. The method includes associating a first data item and a first function with an identifier based on a user action performed in a source location. Further, the method includes associating a second data item and a second function with the identifier based on the user action performed by the user in the source location. Furthermore, the method includes performing the first function and the second function to transfer the first data item and the second data item from the source location to a target location based on the user action performed on the identifier by the user in the target location.

Still other exemplary embodiments herein relate to a method for transferring data items in an electronic device. The method includes associating a first data item and a first function with an identifier based on a user action performed in a first source location. Further, the method includes associating a second data item and a second function with the identifier based on the user action performed by the user in a second source location. Further, the method includes performing the first function and the second function to transfer the first data item from the first source location and the second data item from the second source location to a target location based on the user action performed on the identifier by the user in the target location.

In related art systems, when a user copies or moves multiple files in different source locations to the target location, the user needs to copy or move (e.g., cut) each file individually from one source location and place each file individually in the target location. Thus, a large amount of effort and time, and a large number of clicks are needed to copy or move multiple files in different source locations to a target location.

Unlike related art systems, the various exemplary embodiments herein minimize the number of user clicks used to copy or move files from multiple source locations to target locations. Accordingly, the user time and effort, and the number of clicks are reduced, thus improving the user experience. The various exemplary embodiments reduce the time and effort, and the number of clicks used, for example, by combining multiple files by logically grouping a large number of files from different folders only once in the target region. Further, the grouped files in the target region may be copied to a target location.

Unlike related art systems, the number of clicks while performing file function may be drastically reduced. In a case involving copying or moving a large number of files, the technology of the various exemplary embodiments may drastically reduce the number of clicks used; thereby, saving time. The focus is shifted to the number of targets and which file will go in which target folder.

Throughout the description, the terms “Display Screen” and “Screen” are used interchangeably.

Throughout the description, the labels such as “first”, “second”, and “third” are used merely to differentiate data items and source locations and do not limit the scope of the inventive concept.

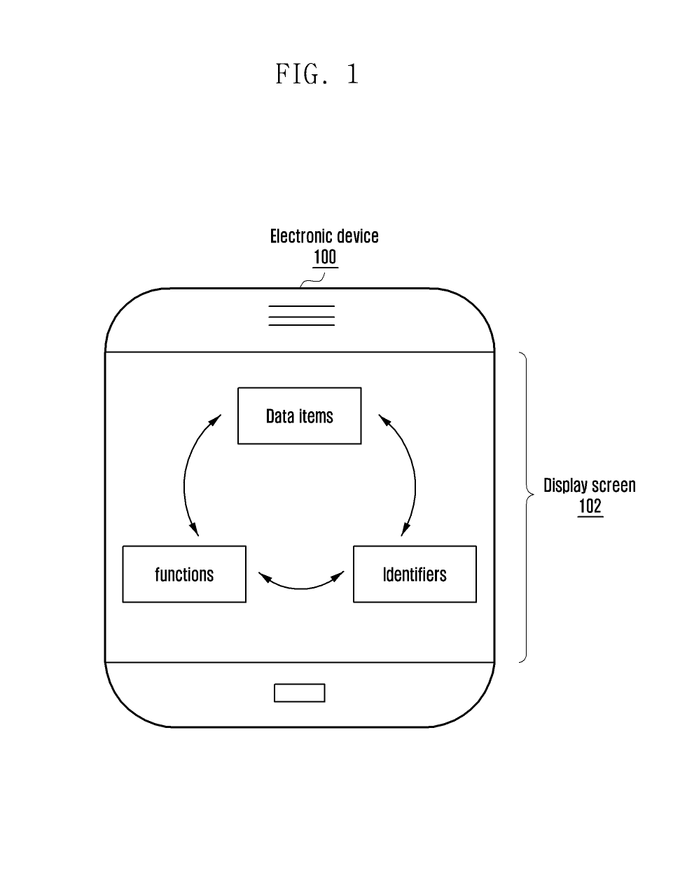

Referring now to the drawings, and more particularly to FIGS. 1 through 16, where similar reference characters denote corresponding features consistently throughout FIG.ures, there are shown various exemplary embodiments.

FIG. 1 illustrates an electronic device 100 for transferring one or more data items from a same source location or multiple source locations to a target location, according to exemplary embodiments. The electronic device 100 may be, for example but not limited to, a laptop, a desktop computer, a mobile phone, a smart phone, a Personal Digital Assistant (PDA), a tablet, a phablet, a consumer electronic device, a server, or any other electronic device. The transferring one or more data items comprises at least one of copying, cutting and pasting the one or more data items.

The electronic device 100 includes a display screen 102. Initially, a user performs a gesture (not shown in FIG. 1) on the display screen 102 of the electronic device 100 to initiate the transfer of one or more data items. In some exemplary embodiments, the gesture performed by the user may be, for example but not limited to, a double swipe gesture on the display screen 102 of the electronic device 100 from one end of the screen 102 to the other end. The double swipe gesture may be, for example, a case in which a user presses two fingers to the screen at one end of the screen 102, and swipes the two fingers across the screen 102 to the other end of the screen.

Further, the display screen 102 provides the user with one or more identifiers for associating one or more data items with one of a “COPY” function or a “CUT” function. In some exemplary embodiments, the identifier may be, for example but not limited to, a number, a marker, a flag, or the like. For example, the marker may be a color marker. In some exemplary embodiments, the data item may be, for example but not limited to, a folder, a file, or the like. For example, the file may be an image, a video, a PDF document, a word document, or the like.

In some exemplary embodiments, the “COPY” function may be marked by selecting a particular marker and subsequently performing a gesture on a left portion of the file name. This combined function of selecting the marker and performing the gesture will mark the file with the selected marker and will associate the “COPY” function with the marked file.

In some exemplary embodiments, the “CUT” function may be marked by selecting a particular marker and subsequently performing a gesture on the right portion of the file name. This combined function of selecting the marker and performing the gesture will mark the file with the selected marker and will associate “CUT” function with the marked file.

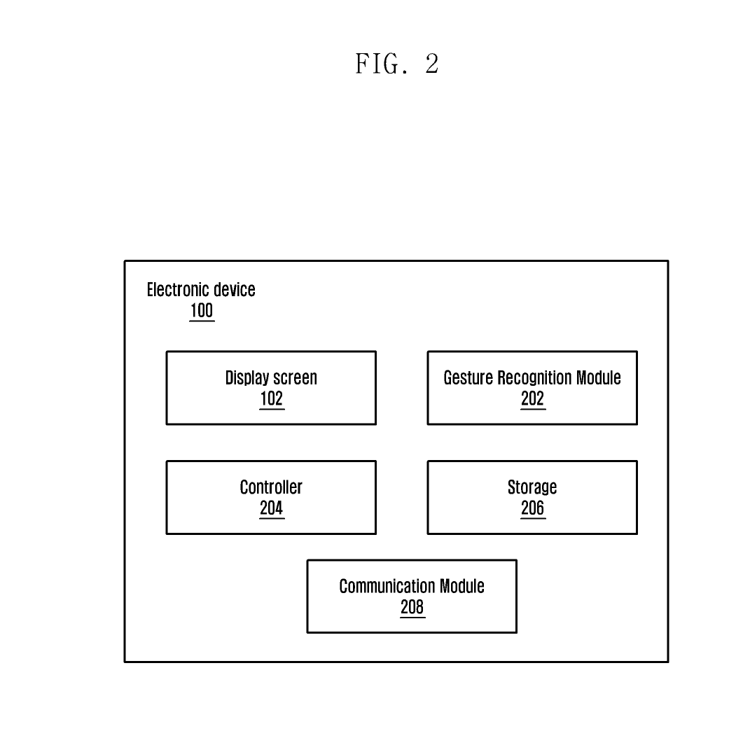

Further, the association of the data items and the function with the identifier may be in any order. In some exemplary embodiments, the identifier may be dragged to the data item and then the data item may be dragged to the function. In an example, in some exemplary embodiments, a particular color marker may be dragged to the image file and then the image file may be dragged to the “COPY” function. In other exemplary embodiments, the data item may be dragged to the identifier and then the identifier may be dragged to the function. In an example, the video file may be dragged to the particular color marker and then the particular color marker may be dragged to the “CUT” function. Further, the functionalities of the electronic device 100 will be described in conjunction with FIG. 2.

For example, the files may be marked with different colors denoting a group. The position of the markings will denote the associated function. Thus, the file marked with a “Green” color denotes a group of files (e.g., a group “Green”). Further, if the color “Green” is selected from the color palette at the target location then the associated functions (e.g., “COPY” function, “CUT” function, or “DELETE” function) are executed on all the files of the group “Green”. The target location is selected as a reference to the “COPY” and “CUT” functions.

Further, the user may perform a gesture to de-activate the display screen for transferring data items in the electronic device 100. After identifying the gesture, the user will be re-directed to a normal screen displaying the data items without any additional components (e.g., identifiers, functions) as described above to transfer the data items.

FIG. 1 shows a limited overview of the electronic device 100 but, it is to be understood that other exemplary embodiments are not limited thereto. Further, the electronic device 100 may include different components communicating among each other along with other hardware or software components. For example, the component may be, but is not limited to, a process running in the electronic device, an executable process, a thread of execution, a program, or a computer. By way of illustration, both an application running on an electronic device 100 and the electronic device 100 may be the component.

FIG. 2 illustrates various components of the electronic device 100 for transferring one or more data items from a same source location or multiple source locations to the target location. In some exemplary embodiments, the electronic device 100 includes the display screen 102, a gesture recognition module 202, a controller 204, a storage 206, and a communication module 208.

The display screen 102 may be divided into two regions (e.g., a first region and a second region). In an exemplary embodiment, the display screen 102 may be vertically divided into two regions, where one region identifies the “COPY” function association and another region identifies the “CUT” function association. In another exemplary embodiment, the display screen 102 may be divided into three regions with one region identifying the “COPY” function, another region identifying the “CUT” function, and another region identifying a “DELETE” function. In yet another exemplary embodiment, the display screen 102 may be horizontally divided into two regions. In yet another exemplary embodiment, the “COPY” function, the “CUT” function, and the “DELETE” function may be provided as icons on the display screen 102 of the electronic device 100. Further, the functionalities of the display screen 102 are explained in conjunction with FIG. 1.

In some exemplary embodiments, the gesture recognition module 202 may be configured to identify the gesture performed by the user on the display screen 102 of the electronic device 100 to initiate the transfer of the data items. In some exemplary embodiments, the gesture recognition module 202 may include one or more microprocessors. In other exemplary embodiments, the gesture recognition module 202 may be implemented by one or more microprocessors in conjunction with software code. In some exemplary embodiments, the gesture performed by the user may be, for example but not limited to, a double swipe gesture on the display screen 102 of the electronic device 100 from one end of the screen 102 to the other end. Further, the gesture recognition module 202 may be configured to identify a user action in a source location. The user action comprises a first action.

Further, the controller 204 may be configured to associate the function and the one or more data items with the identifier based on the first action performed by the user in the source location. The controller 204 may include one or more microprocessors. The first action may include a pattern of gestures to be performed on the function and the one or more data items with respect to the identifier, a pattern of gestures to be performed on the identifier and the one or more data items and with respect to the function, a pattern of gestures to be performed on the function and the identifier with respect to the one or more data items, a type of gesture to be performed on the function and the one or more data items with respect to the identifier, a type of gesture to be performed on the identifier and the one or more data items with respect to the function, or a type of gesture to be performed on the function and the identifier with respect to the one or more data items. The pattern of a gesture may be a combination of two gestures forming a pattern. For example, the first action may include a long press on the identifier and a drag action performed on the data item with respect to the function. For example, the type of gesture may be a rotate gesture, the long press, the drag action, a tap, or the like.

Further, the gesture recognition module 202 may be configured to identify a user action performed on the identifier in a target location. The user action comprises a second action. Further, the controller 204 may be configured to perform the function to transfer the one or more data items from the source location to the target location based on the second action performed by the user. The second action may include a pattern of gestures to be performed on the identifier in the target location, or a type of gesture to be performed on the identifier in the target location. In some exemplary embodiments, the controller 204 performs the “COPY” function to transfer the data items from the source location to the target location. In other exemplary embodiments, the controller 204 performs the “CUT” function to transfer the data items from the source location to the target location.

In another exemplary embodiment, the gesture recognition module 202 may be configured to identify the first action performed by the user in the source location. Further, the controller 204 may be configured to associate the one or more data items with the identifier based on the first action performed by the user in the source location. Further, the gesture recognition module 202 may be configured to identify a second action performed by the user in the target location. Further, the controller 204 may be configured to associate the identifier with the function based on the second action performed by the user in the target location. Further, the controller 204 may be configured to perform the function to transfer the one or more data items from the source location to the target location.

In another exemplary embodiment, the gesture recognition module 202 may be configured to identify a first action performed by the user in the source location. Further, the controller 204 may be configured to associate a first data item and a first function with the identifier based on the first action performed by the user in the source location. The first action may include a pattern of gestures to be performed on the first data item and the first function with respect to the identifier, a pattern of gestures to be performed on the first data item and the identifier with respect to the first function, a pattern of gestures to be performed on the first function and the identifier with respect to the first data item, a type of gesture to be performed on the first data item and the first function with respect to the identifier, a type of gesture to be performed on the first data item and the identifier with respect to the first function, or a type of gesture to be performed on the first function and the identifier with respect to the first data item.

Further, the gesture recognition module 202 may be configured to identify a second action performed by the user in the source location. Further, the controller 204 may be configured to associate a second data item and a second function with the identifier based on the second action performed by the user in the source location. The second action may include a pattern of gestures to be performed on the second data item and the second function with respect to the identifier, a pattern of gestures to be performed on the second data item and the identifier with respect to the second function, a pattern of gestures to be performed on the second function and the identifier with respect to the second data item, a type of gesture to be performed on the second data item and the second function with respect to the identifier, a type of gesture to be performed on the second data item and the identifier with respect to the second function, or a type of gesture to be performed on the second function and the identifier with respect to the second data item.

Further, the gesture recognition module 202 may be configured to identify a user action performed on the identifier in the target location. The user action comprises a third action. Further, the controller 204 may be configured to perform the first function and the second function to transfer the first data item and the second data item from the source location to the target location based on the third action performed on the identifier by the user in the target location. The third action may include a pattern of gestures to be performed on the identifier in the target location, or a type of gesture to be performed on the identifier in the target location.

In another exemplary embodiment, the gesture recognition module 202 may be configured to identify the first action performed by the user in a first source location. Further, the controller 204 may be configured to associate the first data item and the first function with the identifier based on the first action performed by the user in the first source location.

Further, the gesture recognition module 202 may be configured to identify the second action performed by the user in a second source location. Further, the controller 204 may be configured to associate the second data item and the second function with the identifier based on the second action performed by the user in the second source location.

Further, the gesture recognition module 202 may be configured to identify the third action performed by the user in the target location. Further, the controller 204 may be configured to perform the first function and the second function to transfer the first data item from the first source location and the second data item from the second source location to the target location based on the third action performed on the identifier by the user in the target location.

The storage 206 may encompass one or more memory devices of any of a variety of forms (e.g., read-only memory, random access memory, static random access memory, dynamic random access memory, etc.), and may be used by the controller 204 to store and retrieve data. The data that is stored by the storage 206 may include operating systems, applications, and informational data. Each operating system includes executable code that controls basic functions of the electronic device 100, such as interaction among the various internal components, communication with external devices via wireless or wired transceivers or the component interface, and storage and retrieval of applications and data to and from the storage 206.

The communication module 208 may be configured to transfer the set of instructions internally between the various components in the electronic device 100. The communication module may be, for example but not limited to, a bus controller.

Unlike related art systems, exemplary embodiments combine multiple files from different folders once and then copy the files into the target location. Accordingly, a number of clicks used in transferring the files may be reduced and time and effort may be saved. The files belonging to the same target location may be logically grouped by using, for example, color markers, and one of the “COPY” function and the “CUT” function may be associated with the selected files.

FIG. 2 shows a limited overview of the components of the electronic device 100 but, it is to be understood that other exemplary embodiments are not limited thereto. Further, the electronic device 100 may include different components communicating among each other along with other hardware or software components. For example, the components may be, but are not limited to, a process running in the electronic device 100, an executable process, a thread of execution, a program, or a computer. By way of illustration, both an application running on an electronic device 100 and the electronic device 100 may be the component.

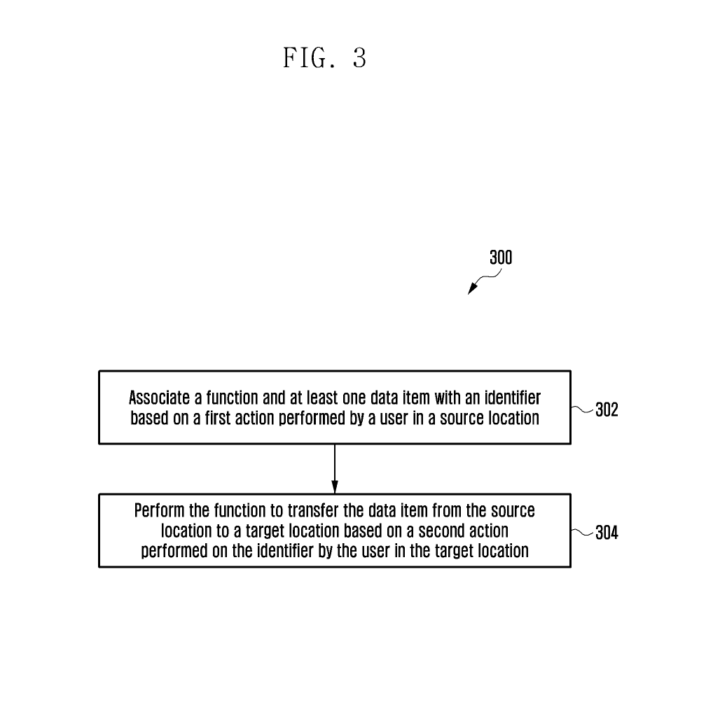

FIG. 3 is a flow diagram illustrating a method 300 for transferring one or more data items from the source location to the target location in the electronic device 100, according to exemplary embodiments.

At function 302, the method 300 includes associating a function and one or more data items with an identifier based on a first action performed by the user in a source location. The method 300 allows the controller 204 to associate the function and the one or more data items with the identifier based on the first action performed by the user in the source location. In some exemplary embodiments, the identifier may be, for example but not limited to, a number, a marker, a flag, or the like. For example, the marker may be a color marker. In some exemplary embodiments, the data item may be, for example but not limited to, a folder, a file, or the like. For example, the file may be an image, a video, a PDF document, a word document, or the like. In some exemplary embodiments, the function may be a “COPY” function, a “CUT” function, or a “DELETE” function.

In some exemplary embodiments, the first action may include a pattern of gestures to be performed on the function and the one or more data items with respect to the identifier, a pattern of gestures to be performed on the identifier and the one or more data items and with respect to the function, a pattern of gestures to be performed on the function and the identifier with respect to the one or more data items, a type of gesture to be performed on the function and the one or more data items with respect to the identifier, a type of gesture to be performed on the identifier and the one or more data items with respect to the function, or a type of gesture to be performed on the function and the identifier with respect to the one or more data items. The pattern of the gesture may be a combination of two gestures forming a pattern. For example, the first action may include a long press on the identifier and a drag action performed on the data item with respect to the function. For example, the type of gesture may be a rotate gesture, a long press, a drag action, a tap, or the like.

At function 304, the method 300 includes performing the function to transfer the one or more data items from the source location to the target location based on the second action performed on the identifier by the user in the target location. The method 300 allows the controller 204 to perform the function to transfer the data items from the source location to the target location based on the second action performed on the identifier by the user in the target location. In some exemplary embodiments, the second action may include the pattern of gestures to be performed on the identifier in the target location or the type of gesture to be performed on the identifier in the target location.

Unlike related art systems, multiple files from the same source location or from multiple source locations may be copied or cut by marking files having the same target with a particular marker thereby reducing the number of clicks when the files are to be copied or cut to the multiple folders.

The various actions, acts, blocks, functions, or the like in the method 300 may be performed in the order presented, in a different order or simultaneously. Further, in some exemplary embodiments, some of the actions, acts, blocks, functions, or the like may be omitted, added, modified, skipped, or the like without departing from the scope of the inventive concept.

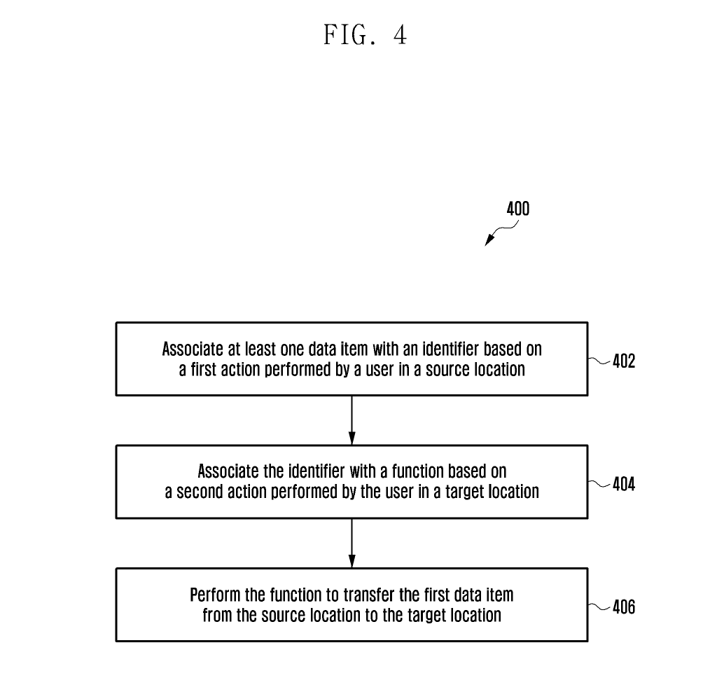

FIG. 4 is another flow diagram illustrating a method 400 for transferring one or more data items from the source location to the target location in the electronic device 100, according to exemplary embodiments.

At function 402, the method 400 includes associating one or more data items with an identifier based on a first action performed by a user in a source location. The method 400 allows the controller 204 to associate one or more data items with the identifier based on the first action performed by the user in the source location. In some exemplary embodiments, the identifier may be, for example but not limited to, a number, a marker, a flag, or the like. For example, the marker may be a color marker. In some exemplary embodiments, the data item may be, for example but not limited to, a folder, a file, or the like. For example, the file may be an image, a video, a PDF document, a word document, or the like. In some exemplary embodiments, the function may be a “COPY” function, a “CUT” function, or a “DELETE” function.

At function 404, the method 400 includes associating the identifier with the function based on a second action performed by the user in a target location. The method 400 allows the controller 204 to associate the identifier with the function based on the second action in the target location.

At function 406, the method 400 includes performing the function to transfer the first data item from the source location to the target location. The method 400 allows the controller 204 to perform the function to transfer the first data item from the source location to the target location.

Unlike related art systems, exemplary embodiments logically group files from the same or multiple source locations together depending on the common target location. Further, the file functions that are to be executed on each selected file may be defined at the time of selection. Further, at the target location, the user can view the files and their functions. Accordingly, the user may group files logically and perform function at different levels, e.g., the user can select to execute a function on the group marked by a color “Green” or execute functions on one of the subtype of files belonging to the same group.

The various actions, acts, blocks, functions, or the like in the method 400 may be performed in the order presented, in a different order or simultaneously. Further, in some exemplary embodiments, some of the actions, acts, blocks, functions, or the like may be omitted, added, modified, skipped, or the like without departing from the scope of the inventive concept.

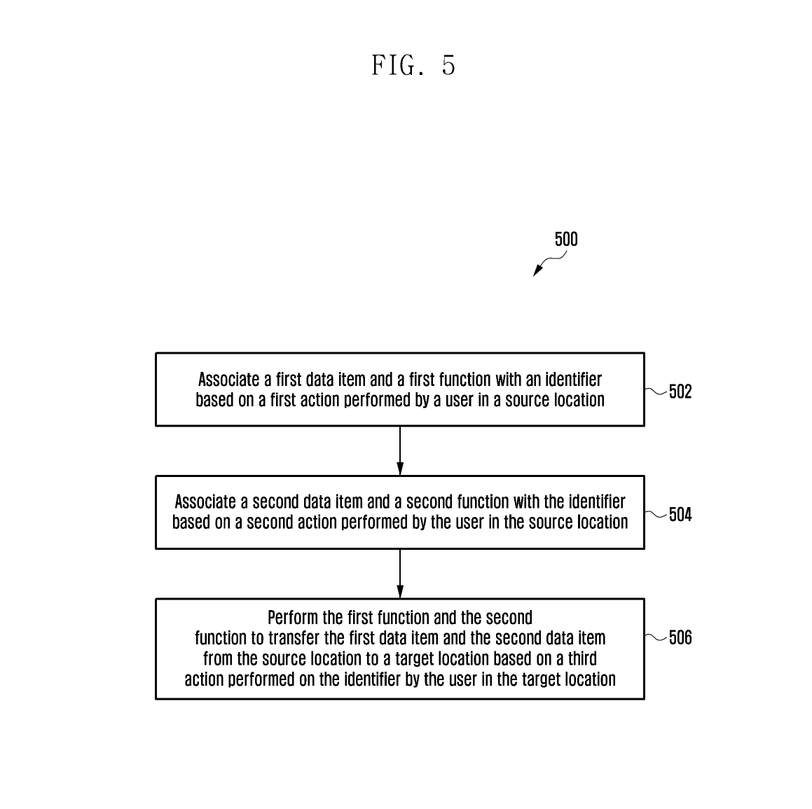

FIG. 5 is another flow diagram illustrating a method 500 for transferring the first data item by performing the first function and the second data item by performing the second function from the source location to the target location in the electronic device 100, according to exemplary embodiments.

At function 502, the method 500 includes associating a first data item and a first function with an identifier based on a first action performed by a user in a source location. The method 500 allows the controller 204 to associate the first data item and the first function with the identifier based on the first action in the source location. In some exemplary embodiments, the identifier may be, for example but not limited to, a number, a marker, a flag, or the like. For example, the marker may be a color marker. In some exemplary embodiments, the data item may be, for example but not limited to, a folder, a file, or the like. For example, the file may be an image, a video, a PDF document, a word document, or the like. In some exemplary embodiments, the function may be a “COPY” function, a “CUT” function, or a “DELETE” function.

In some exemplary embodiments, the first action may include a pattern of gestures to be performed on the function and the one or more data items with respect to the identifier, a pattern of gestures to be performed on the identifier and the one or more data items and with respect to the function, a pattern of gestures to be performed on the function and the identifier with respect to the one or more data items, a type of gesture to be performed on the function and the one or more data items with respect to the identifier, a type of gesture to be performed on the identifier and the one or more data items with respect to the function, or a type of gesture to be performed on the function and the identifier with respect to the one or more data items. The pattern of the gesture may be a combination of two gestures forming a pattern. For example, the first action may include a long press on the identifier and a drag action performed on the data item with respect to the function. For example, the type of gesture may be a rotate gesture, a long press, a drag action, a tap, or the like.

At function 504, the method 500 includes associating a second data item and a second function with the identifier based on a second action performed by the user in the source location. The method 500 allows the controller 204 to associate the second data item and the second function with the identifier based on the second action performed by the user in the source location. In some exemplary embodiments, the second action may include a pattern of gestures to be performed on the second data item and the second function with respect to the identifier, a pattern of gestures to be performed on the second data item and the identifier with respect to the second function, a pattern of gestures to be performed on the second function and the identifier with respect to the second data item, a type of gesture to be performed on the second data item and the second function with respect to the identifier, a type of gesture to be performed on the second data item and the identifier with respect to the second function, or a type of gesture to be performed on the second function and the identifier with respect to the second data item. For example, the second action may include a long press on the identifier and a drag action performed on the second data item with respect to the second function.

At function 506, the method 500 includes performing the first function and the second function to transfer the first data item and the second data item from the source location to a target location based on a third action performed on the identifier by the user in the target location. The method 500 allows the controller 204 to perform the first function and the second function to transfer the first data item and the second data item from the source location to the target location based on the third action performed on the identifier by the user in the target location. In some exemplary embodiments, the third action includes a pattern of gestures to be performed on the identifier in the target location, or a type of gesture to be performed on the identifier in the target location. For example, the third action may include a long press on the identifier and a drag action performed on a “COPY” function region or a “CUT” function region in the target location.

The various actions, acts, blocks, functions, or the like in the method 500 may be performed in the order presented, in a different order or simultaneously. Further, in some exemplary embodiments, some of the actions, acts, blocks, functions, or the like may be omitted, added, modified, skipped, or the like without departing from the scope of the inventive concept.

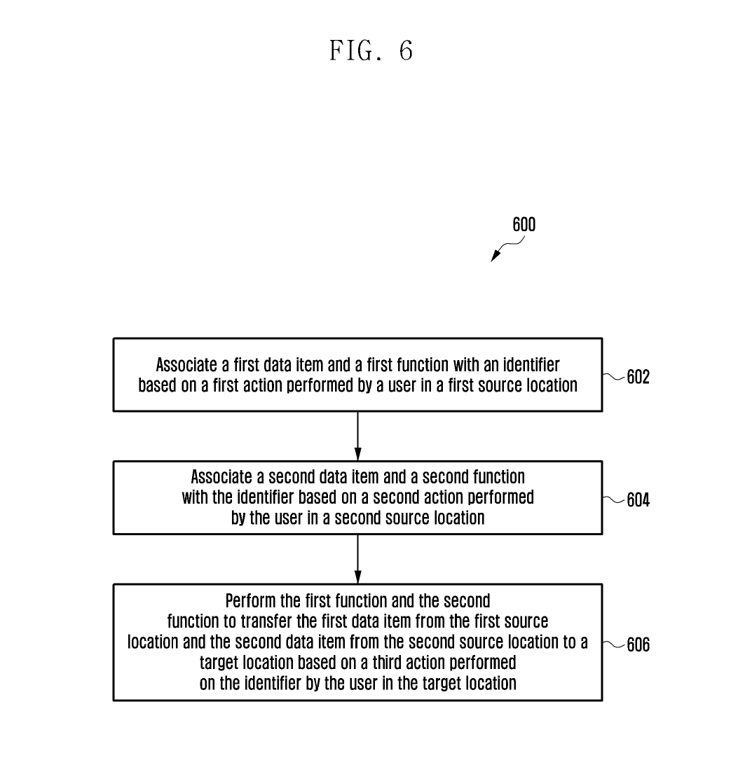

FIG. 6 is another flow diagram illustrating a method 600 for transferring the first data item from the first source location and the second data item from the second source location to the target location in the electronic device 100, according to exemplary embodiments.

At function 602, the method 600 includes associating a first data item and a first function with an identifier based on a first action performed by a user in a first source location. The method 600 allows the controller 204 to associate the first data item and the first function with the identifier based on the first action in the first source location. In some exemplary embodiments, the identifier may be, for example but not limited to, a number, a marker, a flag, or the like. For example, the marker may be a color marker. In some exemplary embodiments, the data item may be, for example but not limited to, a folder, a file, or the like. For example, the file may be an image, a video, a PDF document, a word document, or the like. In some exemplary embodiments, the function may be a “COPY” function, a “CUT” function, or a “DELETE” function.

At function 604, the method 600 includes associating a second data item and a second function with the identifier based on a second action performed by the user in a second source location. The method 600 allows the controller 204 to associate the second data item and the second function with the identifier based on the second action in the second source location.

At function 606, the method 600 includes performing the first function and the second function to transfer the first data item from the first source location and the second data item from the second source location to a target location based on a third action performed on the identifier by the user in the target location. The method 600 allows the controller 204 to perform the first function and the second function to transfer the first data item from the first source location and the second data item from the second source location to the target location based on the third action on the identifier in the target location.

The various actions, acts, blocks, functions, or the like in the method 600 may be performed in the order presented, in a different order or simultaneously. Further, in some embodiments, some of the actions, acts, blocks, functions, or the like may be omitted, added, modified, skipped, or the like without departing from the scope of the invention.

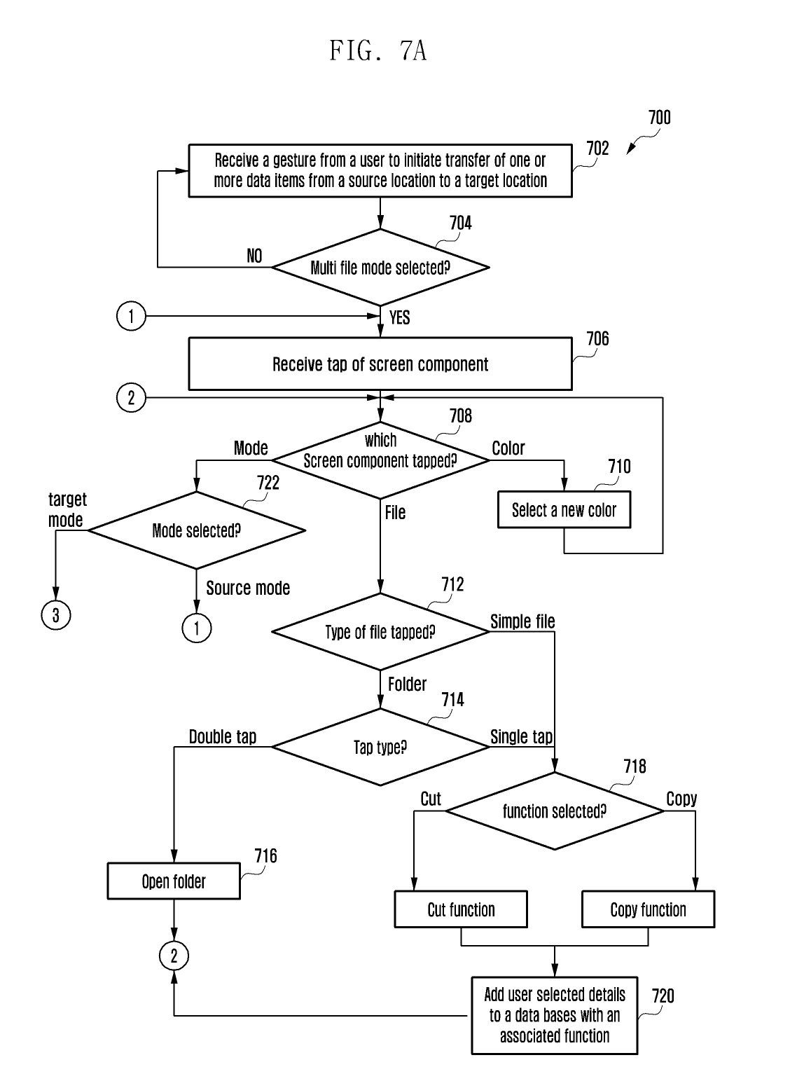

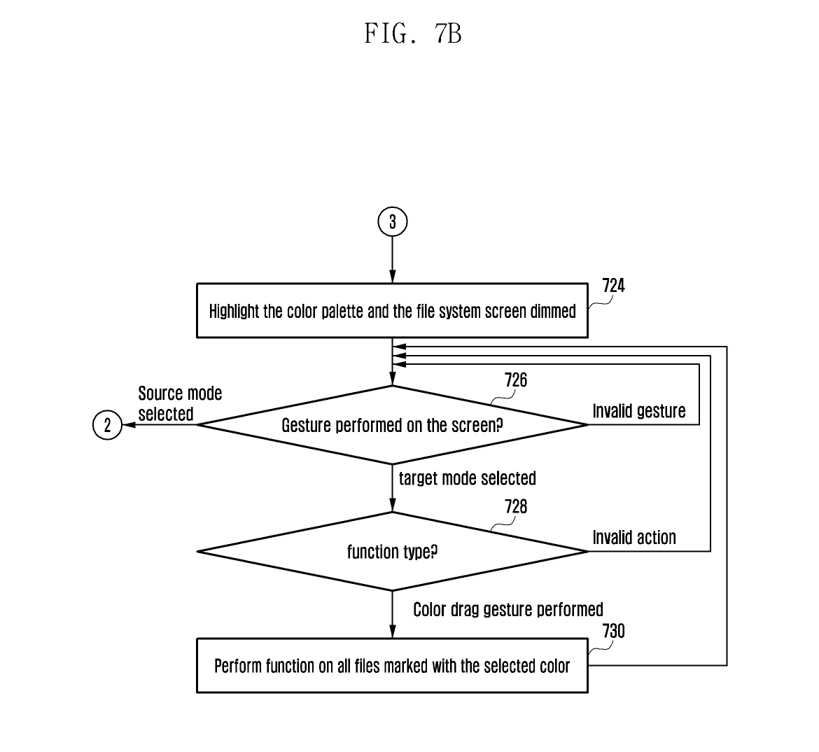

FIGS. 7A and 7B are another flow diagram illustrating a method 700 for transferring one or more data items from a source location to a target location in the electronic device 100, according to exemplary embodiments. The sequence of functions may be performed by using the controller 204, the microprocessor, or any computer readable storage medium.

At function 702, the method 700 includes receiving a gesture from a user to initiate a transfer of data items from a source location to a target location. In operation 704, it is determined whether a multi file mode is selected. If it is determined that the multi file mode is selected (function 704, YES), a tap of a screen component is received in function 706.

If it is determined that the multi file mode is not selected (operation 704, NO), the method loops back to function 702. In function 708, it is determined which a screen component is tapped. If it is determined that a color screen component is tapped (function 708, Color), a new color is selected in function 710 and the method 700 is looped back to function 708.

If it is determined that the file screen component is tapped by the user (function 708, File), the method 700 includes determining the type of file tapped by the user in function 712. If it is determined that the type of file tapped is a simple file (function 712, Simple file), the method 700 includes determining the function selected by the user in function 718. If it is determined that the function selected by the user is the “CUT” function (function 718, Cut), the method 700 includes adding user selected details to a database with the associated “CUT” function in function 720. If it is determined, at function 718, that the function selected by the user is the “COPY” function (function 718, Copy), the method 700 includes adding user selected details to a database with the associated “COPY” function in function 720.

In some exemplary embodiments, the database includes the files, functions (e.g., the “COPY” function or the “CUT” function), and color marker. For example, an example of the database is shown below:

TABLE 1

| Function | File (Absolute path) | Color marker |
|---|---|---|
| Copy | C:\Users\Pictures\ABC.jpg | Blue |
| Cut | D:\Music\HELLO.mp3 | Black |
| Copy | C:\Users\Pictures\ABC.jpg | Yellow |

As shown in the Table-1, for each file there is the association of the function and the color marker. The association is mapped in the final stage when the final “COPY” or “CUT” function is performed at the target location.

In case where the function, file, and the color are mapped in the initial stage, all the columns will be populated as shown in the Table-1. Further, in case where only one association is done such as the file is assigned with the color marker and not with the “COPY” function or the “CUT” function, or the color marker is assigned to the function, then only the columns would contain values whose association is done. Then in the later stages of the function, the columns are populated. In an example, in the one source location, the user marked the file with the color. Then, at the other source directory, the user associates the same color with the “COPY” function or the “CUT” function, and the columns are completed in the database. Unless all the fields are populated in the database, the functions may not be performed.

Returning to FIG. 7A, if it is determined that the type of file tapped is the folder (function 712, folder), the method 700 includes determining the tap type performed by the user on the screen 102 of the electronic device 100. If it is determined that the tap type is a single tap (function 714, Single tap), the method 700 is linked to function 718 and follows the process as described above. If it is determined that the tap type is a double tap (function 714, Double tap), the method 700 includes opening the folder at function 716, and the method 700 returns to function 708.

If it is determined that the mode screen component is tapped by the user (function 708, Mode), the method 700 includes determining the mode selected by the user in function 722. If it is determined that the mode selected is the source mode (function 722, Source mode), the method 700 is looped back to function 706. If it is determined that the mode selected by the user is the target mode (function 722, Target mode), the method 700 includes highlighting the color palette and the file system screen is dimmed in function 724 of FIG. 7B.

It is then determined if a gesture is performed on the screen in function 726. If it is determined that the gesture performed on the screen is invalid gesture (function 726, Invalid gesture), the method 700 is looped back to function 726. If it is determined that the gesture performed is for selecting the source mode (function 726, Source mode selected), the method 700 is looped back to function 708. If it is determined that the gesture performed is for selecting the target mode (operation 726, Target mode selected), a function type is determined in function 728. If it is determined that the function is an invalid function (function 728, Invalid action), the method 700 is looped back to function 726. If it is determined that the function type is color drag gesture performed (function 728, Color drag gesture performed), the method 700 includes performing the function on all files marked with the selected color in function 730 and the method 700 loops back to function 726.

The various actions, acts, blocks, functions, or the like in the method 700 may be performed in the order presented, in a different order or simultaneously. Further, in some exemplary embodiments, some of the actions, acts, blocks, functions, or the like may be omitted, added, modified, skipped, or the like without departing from the scope of the inventive concept.

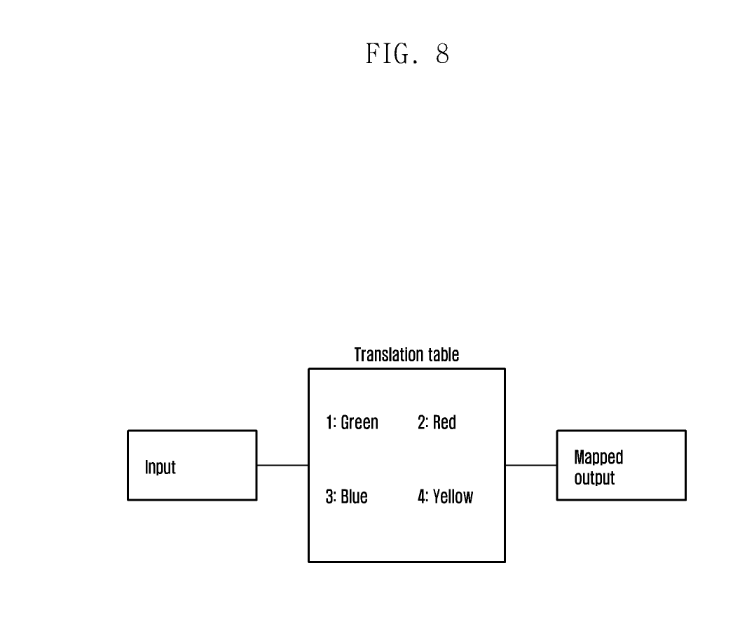

FIG. 8 illustrates a translation table for mapping a number input to a specific color output for transferring data items in the electronic device 100, according to exemplary embodiments. The method for transferring the data items may also be implemented using numbers instead of colors to distinguish the group. This use of numbers may be done by using a translation table that maps each number to a specific color. In the example shown in FIG. 8, the number “1” is mapped to the “Green” color, the number “2” is mapped to a “Red” color, the number “3” is mapped to a “Blue” color, and the number “4” is mapped to a “Yellow” color. Thus, for example, when the number 2 is input, the number “2” is mapped to the “Red” color and the mapped output will be used for associating the data item and the function with respect to the identifier.

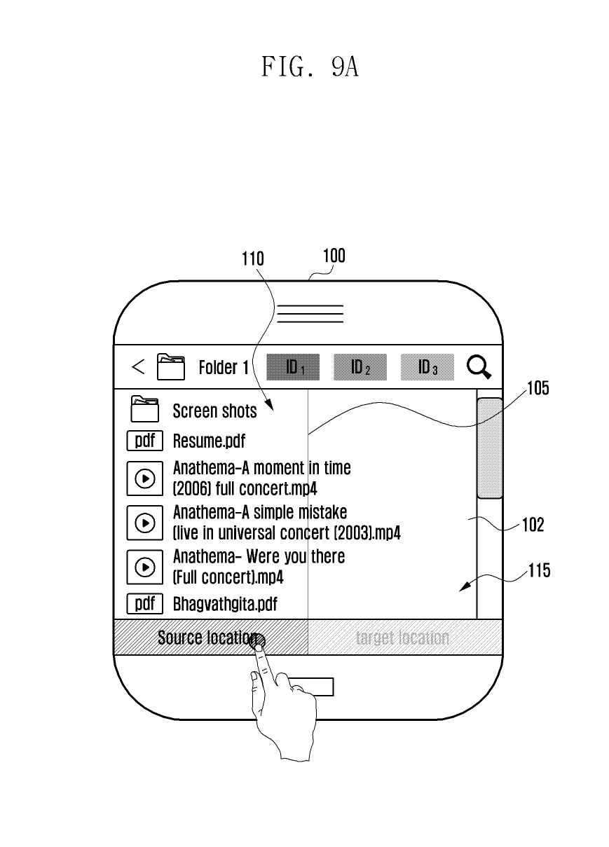

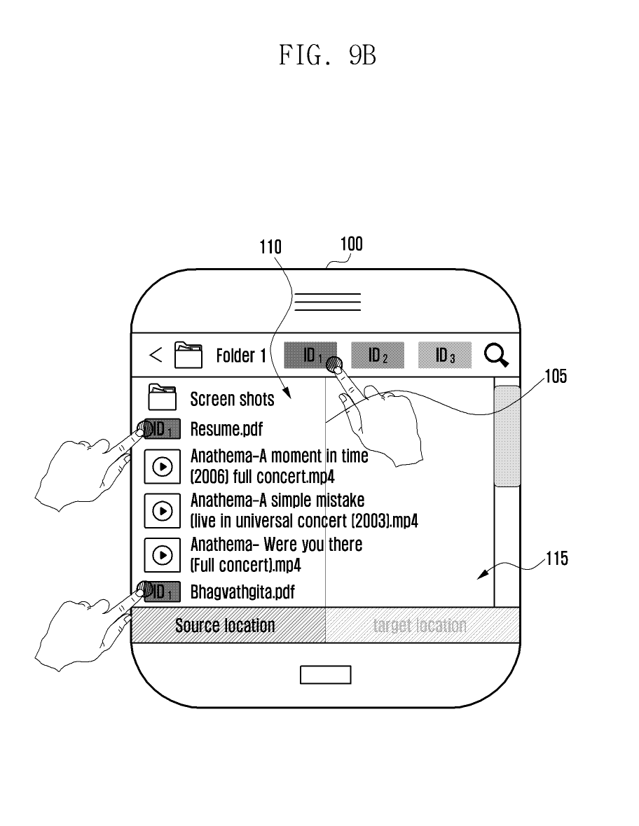

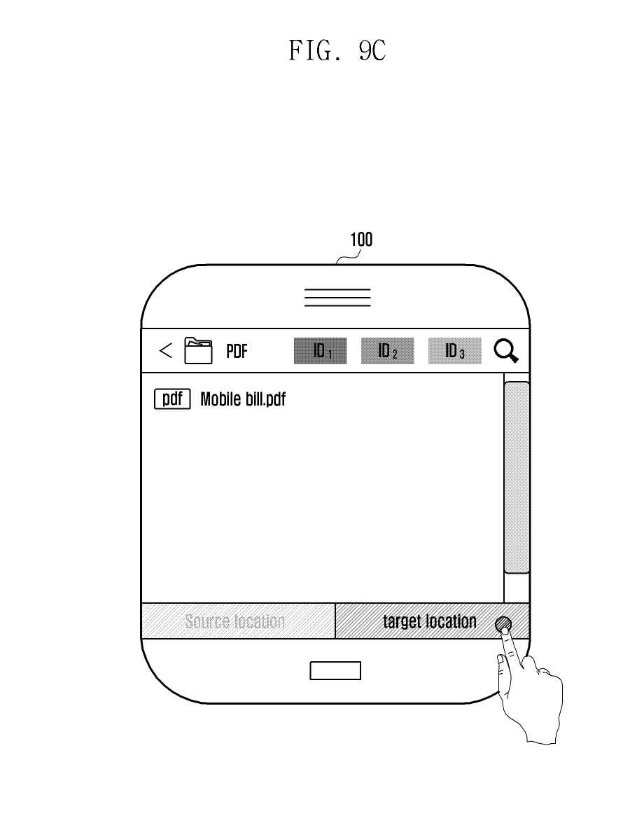

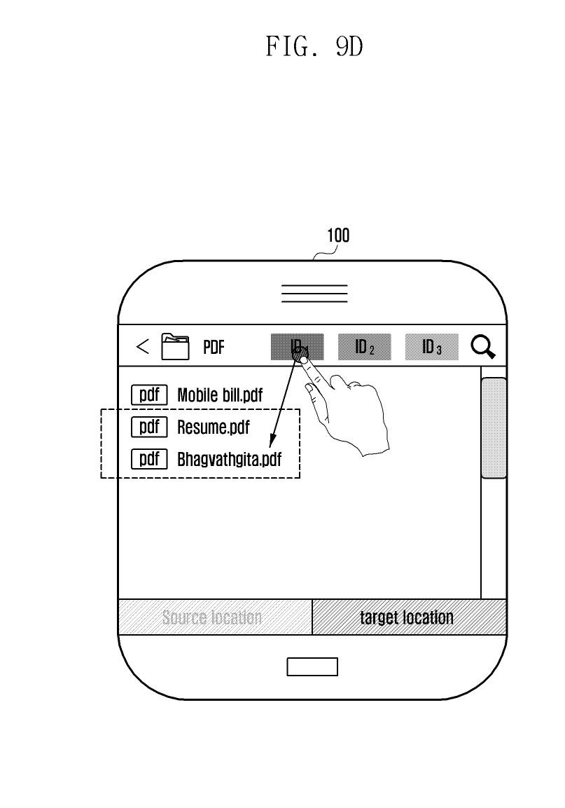

FIGS. 9A to 9D illustrate an example of transferring one or more data items from the source location to the target location in the electronic device 100, according to exemplary embodiments. Consider a scenario in which a user transfers files from a source location to a target location. Initially, the user performs a gesture on the screen 102 of the electronic device 100 to initiate the transfer of the data items. After receiving the gesture from the user, the screen 102 for transferring the data items will be activated as shown in FIG. 9A.

The screen 102 shown in FIG. 9A is vertically divided by a region line 105 into two regions, where a first region 110 identifies the “COPY” function association and a second region 115 identifies the “CUT” function association as shown in FIG. 9A. The region line 105 shown in FIG. 9A may be omitted in some exemplary embodiments. Further, the screen 102 provides the user with a first identifier (id₁), a second identifier (id₂), and a third identifier 3 (id₃) for associating the files (e.g., data items) with the “COPY” function or the “CUT” function. The screen 102 displays a “screen shot” folder and a list of files of a folder “Folder 1”. The list of files includes a “resume.pdf” file, an “Anathema—A moment in time (2006) full concert.mp4” file, an “Anathema-A simple mistake (live in universal concert (2003).mp4” file, an “Anathema—Were you there (Full concert).mp4” file, and a “Bhagvathgita.pdf” file as shown in FIG. 9A.

Further, the user initiates the transfer of files by selecting the “Folder 1” as the source location by performing the gesture on the source location as shown in FIG. 9A. For example, as shown in FIG. 9A, the user may tap on “Source location”. Further, the user performs the first action including the pattern of gestures performed on the first identifier id₁ followed by the “resume.pdf” file, the “Bhagvathgita.pdf” file in the “COPY” function region 110 on the screen 102 to associate the “resume.pdf” file, the “Bhagvathgita.pdf” file and the “COPY” function with the first identifier id₁ as shown in FIG. 9B. For example, the user may tap on each of the “resume.pdf” file, the “Bhagvathgita.pdf” file in the “COPY” function region 110, and tap on the first identifier id₁.

Further, the user selects a PDF folder as the target location as shown in FIG. 9C. Then, as shown in FIG. 9D, the user performs a second action, e.g., performing a long press on the id₁ and a drag action performed in the target location to perform the “COPY” function to transfer the “resume.pdf file” and the “Bhagvathgita.pdf” file from the “Folder 1” to the PDF folder.

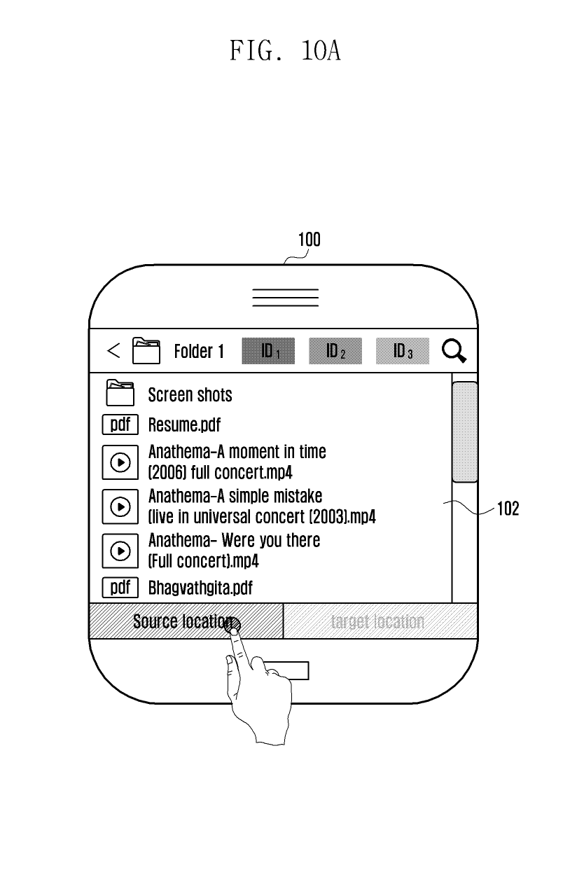

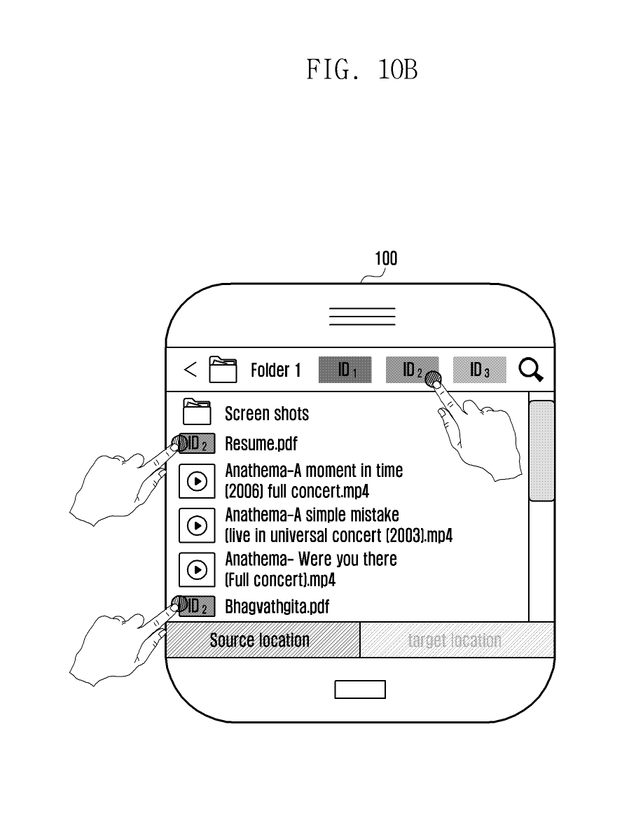

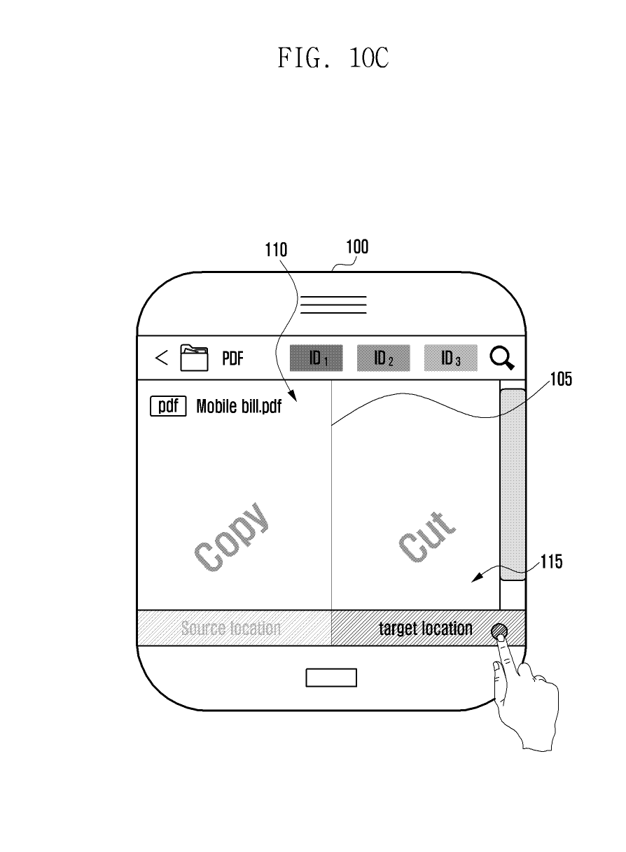

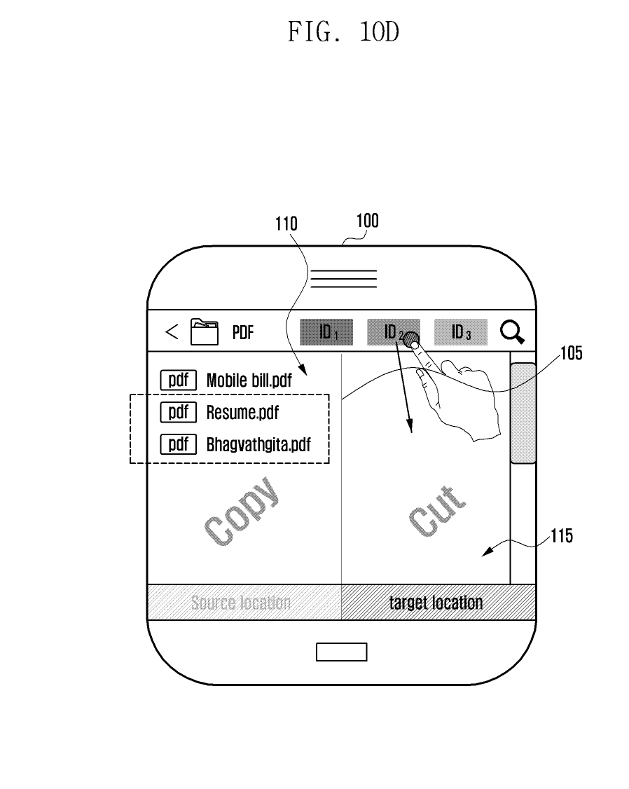

FIGS. 10A to 10D illustrate an example of transferring one or more data items from a source location to a target location in the electronic device 100, according to exemplary embodiments. Consider a scenario where the user transfers files from the source location to the target location. Initially, the user performs the gesture on the screen 102 of the electronic device 100 to initiate the transfer of the data items. After receiving the gesture from the user, the screen 102 for transferring the data items will be activated as shown in FIG. 10A.

Further, the screen 102 provides the user with the first identifier (id₁), the second identifier (id₂), and the third identifier (id₃) for associating the files with the “COPY” function or the “CUT” function. The screen 102 displays the list of files and the “Screen shots” folder of the folder “Folder 1”. The list of files includes a “resume.pdf” file, an “Anathema—A moment in time (2006) full concert.mp4” file, an “Anathema-A simple mistake (live in universal concert (2003).mp4” file, an “Anathema—Were you there (Full concert).mp4” file, and a “Bhagvathgita.pdf” file as shown in FIG. 10A.

Further, the user initiates the transfer of files by selecting the “Folder 1” as the source location by performing the gesture as shown in FIG. 10A. Further, as shown in FIG. 10B, the user performs the first action including the pattern of gestures performed on the second identifier id₂ followed by the “Resume.pdf” file and the “Bhagvathgita.pdf” file on the screen 102 to associate the “Resume.pdf” file and the “Bhagvathgita.pdf” file with the second identifier id₂.

Further, the user selects the PDF folder as the target location as shown in FIG. 10C. After selecting the target location, the screen 102 is vertically divided into two regions by a region line 105, where a first region 110 identifies a “COPY” function association and a second region 115 identifies a “CUT” function association as shown in FIG. 10C. In some exemplary embodiments, the region line 105 may be omitted. As shown in FIG. 10D, the user performs a second action (e.g., performing a long press on the second identifier id₂ and a drag action to the “CUT” function region) to associate the second identifier id₂ with the “CUT” function in the target location. Further, the “CUT” function is performed to transfer the “Resume.pdf” file and the “Bhagvathgita.pdf” file from the folder “Folder 1” to the “PDF” folder as shown in FIG. 10D.

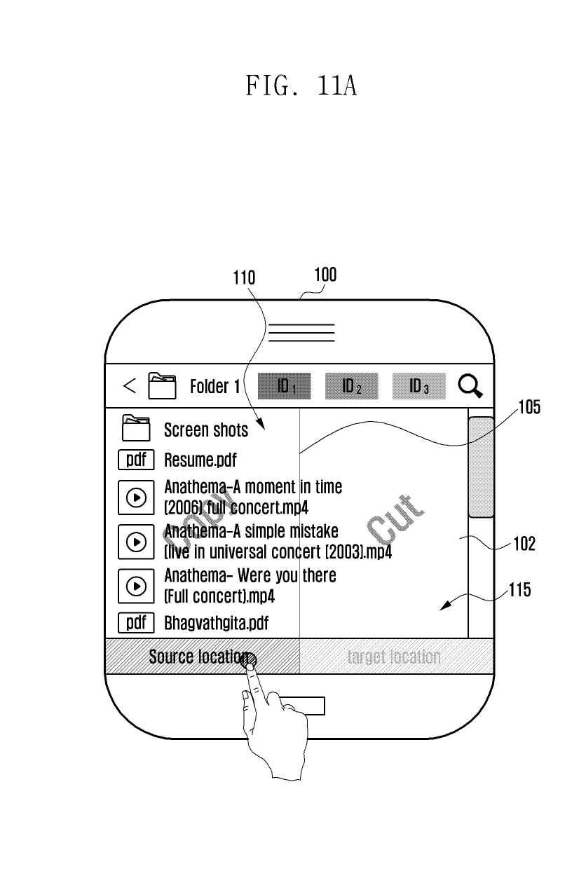

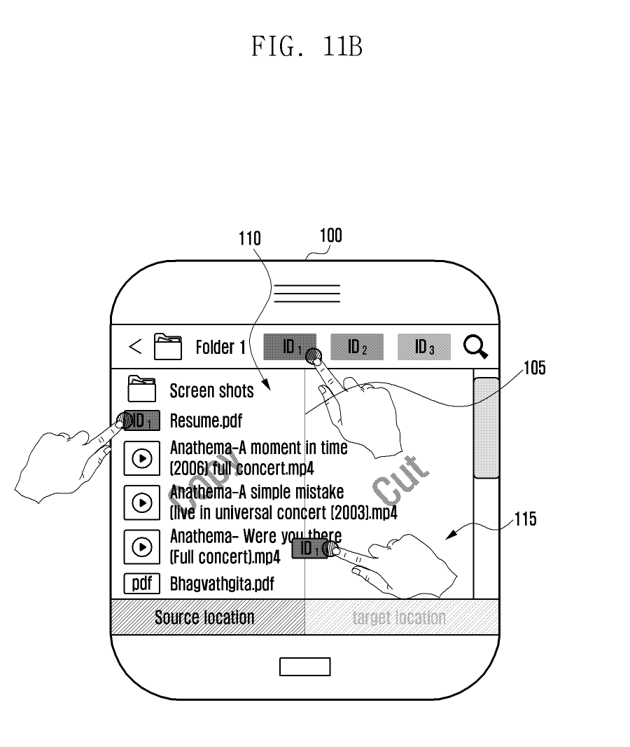

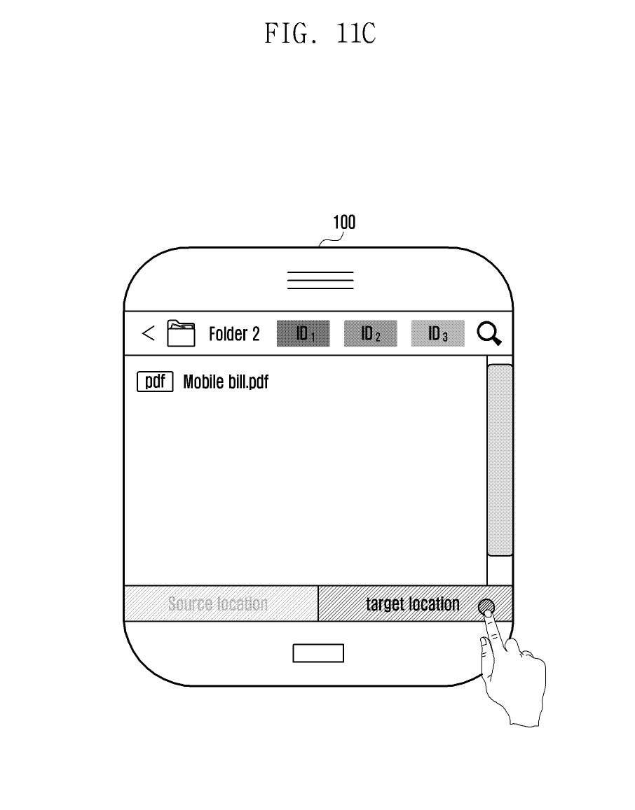

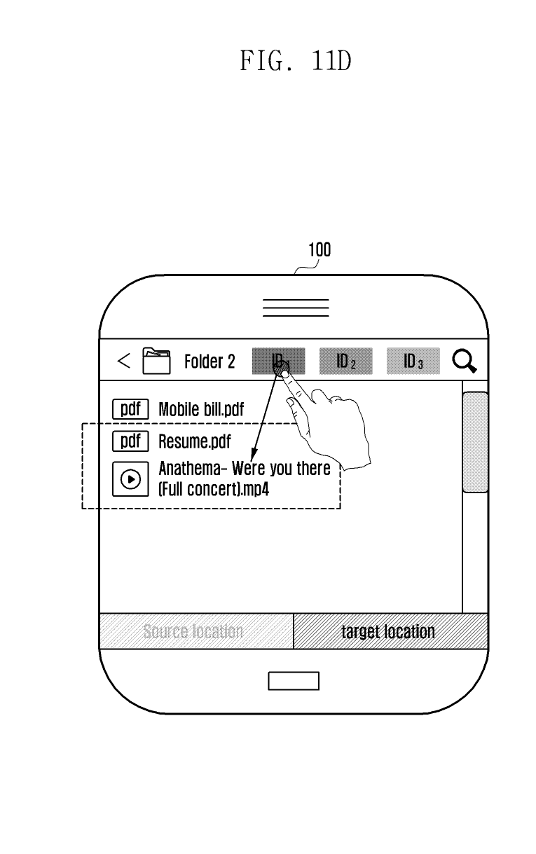

FIGS. 11A to 11D illustrate an example of transferring a first data item by performing a first function and a second data item by performing a second function in the electronic device 100, according to exemplary embodiments. Initially, the user performs the gesture on the screen 102 of the electronic device 100 to initiate the transfer of the data items. After receiving the gesture from the user, the screen 102 for transferring the data items will be activated as shown in FIG. 11A.

Further, the screen 102 is vertically divided into two regions by a region line 105, where a first region 110 identifies a “COPY” function association and a second region 115 identifies a “CUT” function association as shown in FIG. 11A. Further, the screen 102 provides the user with the first identifier (id₁), the second identifier (id₂), and the third identifier (id₃) for associating the files with the “COPY” function or the “CUT” function. The screen 102 displays the list of files and the “Screen shot” folder of folder “Folder 1”.

Further, the user initiates the transfer of files by selecting the “Folder 1” as the source location by performing the gesture as shown in FIG. 11A. Further, as shown in FIG. 11B, the user performs the first action including the pattern of gestures performed on the first identifier id₁ followed by the “Resume.pdf file” (e.g., first data item) in the “COPY” function region on the screen 102 to associate the “Resume.pdf” file and the “COPY” function (e.g., first function) with the first identifier id₁. Further, the user performs the second action (e.g., performing a pattern of gestures on the first identifier id₁ followed by the “Anathema—Were you there (Full concert).mp4” file (e.g., second data item) in the “CUT” function region on the screen 102 to associate the “Anathema—Were you there (Full concert).mp4” file and the “CUT” function (e.g., second function) with the first identifier id₁ as shown in FIG. 11B. In other words, two different functions with associated files may be associated with the same identifier.

Further, the user selects the “Folder 2” as the target location as shown in FIG. 11C. The user performs the third action (e.g., a long press on the first identifier id₁ and a drag action performed in the target location) to perform the “COPY” function and the “CUT” function to transfer the “Resume.pdf” file and the “Anathema—Were you there (Full concert).mp4” file from the folder “Folder 1” to the folder “Folder 2” as shown in FIG. 11D.

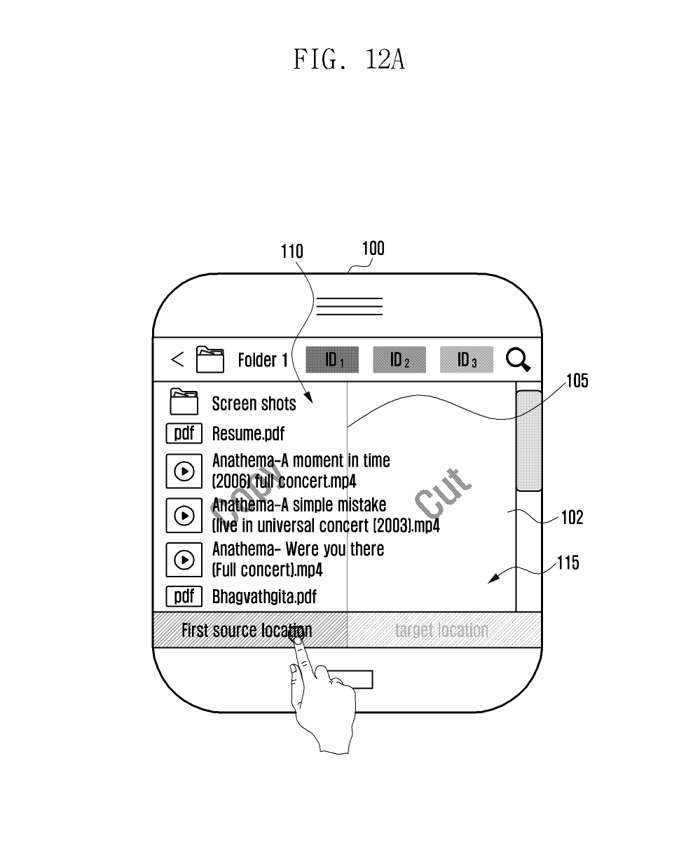

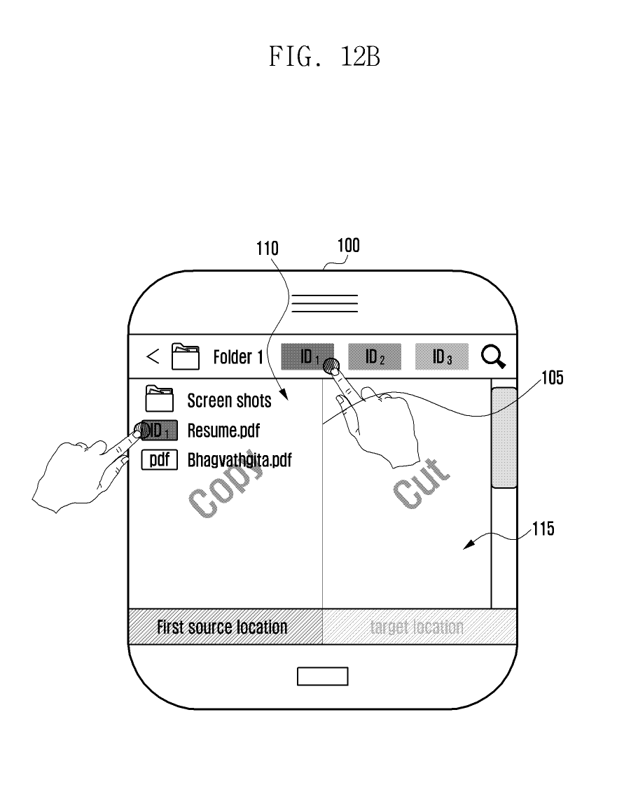

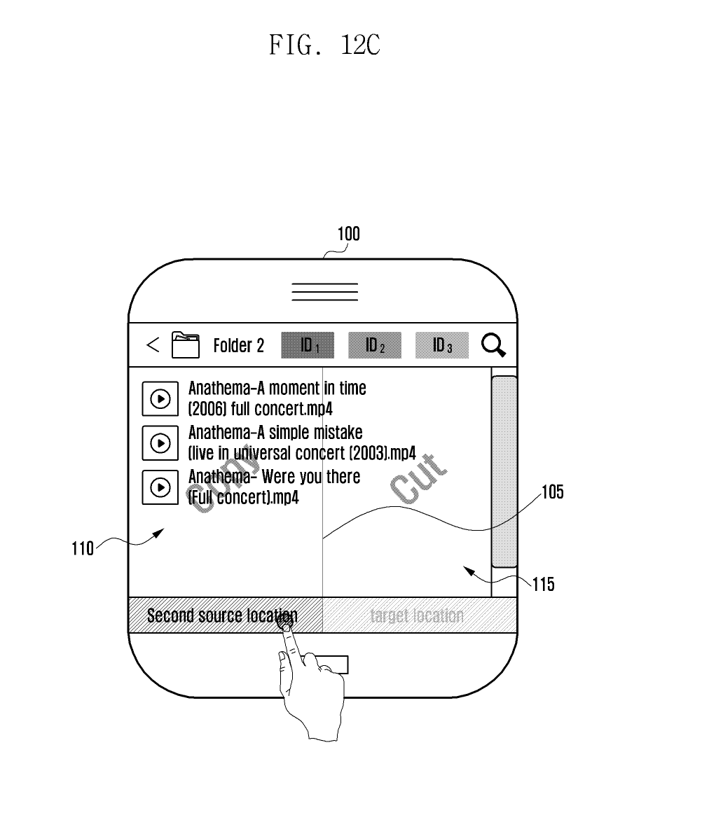

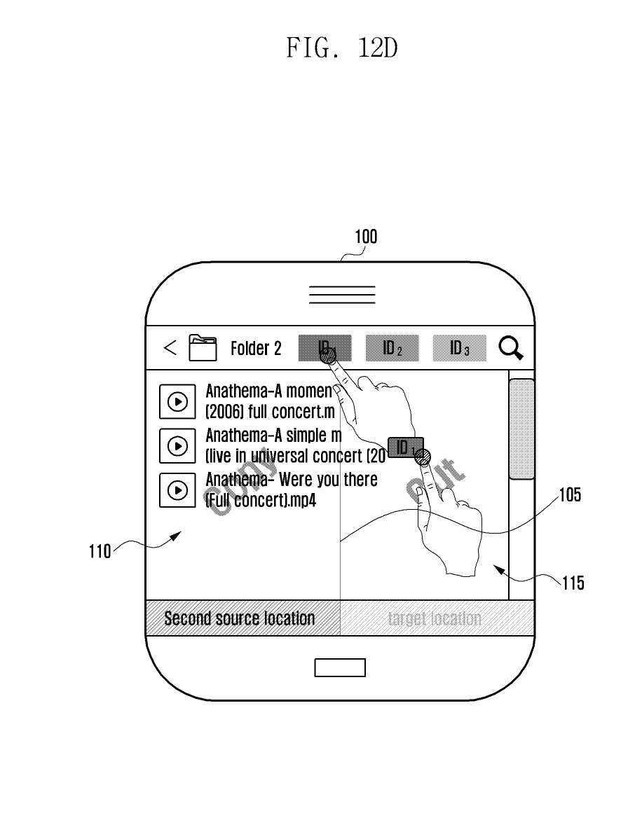

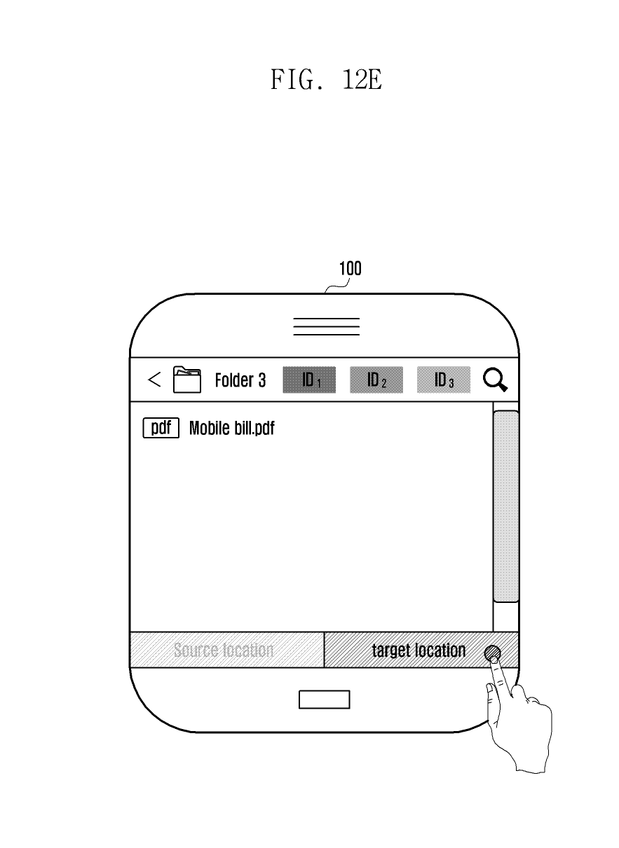

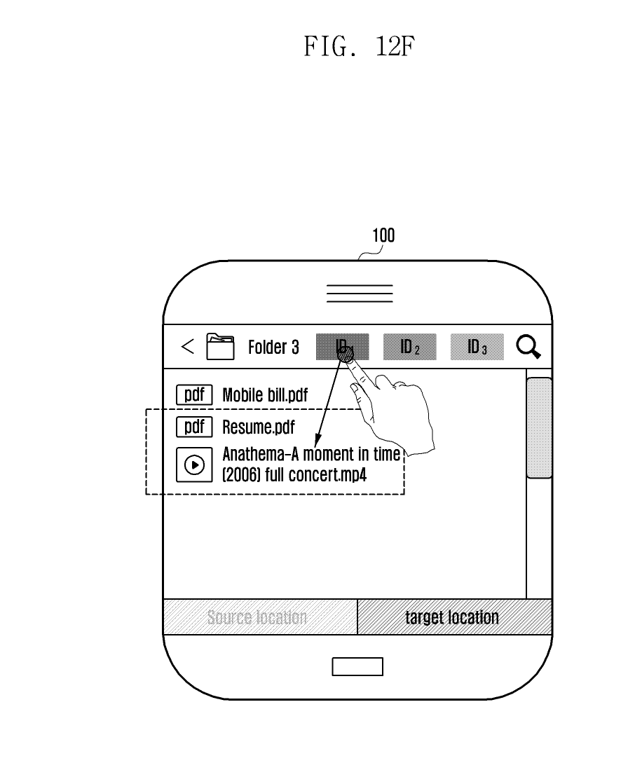

FIGS. 12A to 12F illustrate an example of transferring a first data item by performing a first function from a first source location and a second data item by performing a second function from a second source location in the electronic device 100, according to exemplary embodiments. Initially, the user performs the gesture on the screen 102 of the electronic device 100 to initiate the transfer of the data items. After receiving the gesture from the user, the screen 102 for transferring the data items will be activated as shown in FIG. 12A.

Further, the screen 102 is vertically divided into two regions by a region line 105, where a first region 110 identifies the “COPY” function association and a second region 115 identifies the “CUT” function association as shown in FIG. 12A. Further, the screen 102 provides the user with the first identifier (id₁), the second identifier (id₂), and the third identifier (id₃) for associating the files with the “COPY” function or the “CUT” function. The screen displays the list of files and the “Screen shot” folder of the folder “Folder 1”. The list of files includes a “resume.pdf” file, an “Anathema—A moment in time (2006) full concert.mp4” file, an “Anathema-A simple mistake (live in universal concert (2003).mp4” file, an “Anathema—Were you there (Full concert).mp4” file, and a “Bhagvathgita.pdf” file as shown in FIG. 12A.

Further, the user initiates the transfer of files by selecting the folder “Folder 1” as the first source location by performing the gesture as shown in FIG. 12A. Further, as shown in FIG. 12B, the user performs the first action including the pattern of gestures performed on the first identifier id₁ followed by the “Resume.pdf” file in the “COPY” function region 110 on the screen 102 to associate the “Resume.pdf” file and the “COPY” function (e.g., first function) with the first identifier id₁. Further, as shown in FIG. 12C, the user selects the folder “Folder 2” as the second source location and, as shown in FIG. 12D, performs the second action including the pattern of gestures performed on the first identifier id₁ followed by the “Anathema-A simple mistake (live in universal concert (2003).mp4” file in the “CUT” function region 115 on the screen 102 to associate the “Anathema-A simple mistake (live in universal concert (2003).mp4” file and the “CUT” function (e.g., second function) with the first identifier id₁.

Further, the user selects the folder “Folder 3” as the target location as shown in FIG. 12E. As shown in FIG. 12F, the user performs a third action, e.g., performing a long press on the first identifier id₁ and a drag action performed in the target location, to perform the “COPY” function to transfer the “Resume.pdf” file from the folder “Folder 1” and the “CUT” function to transfer the “Anathema-A simple mistake (live in universal concert (2003).mp4” file from the folder “Folder 2” to the folder “Folder 3” (e.g., target location).

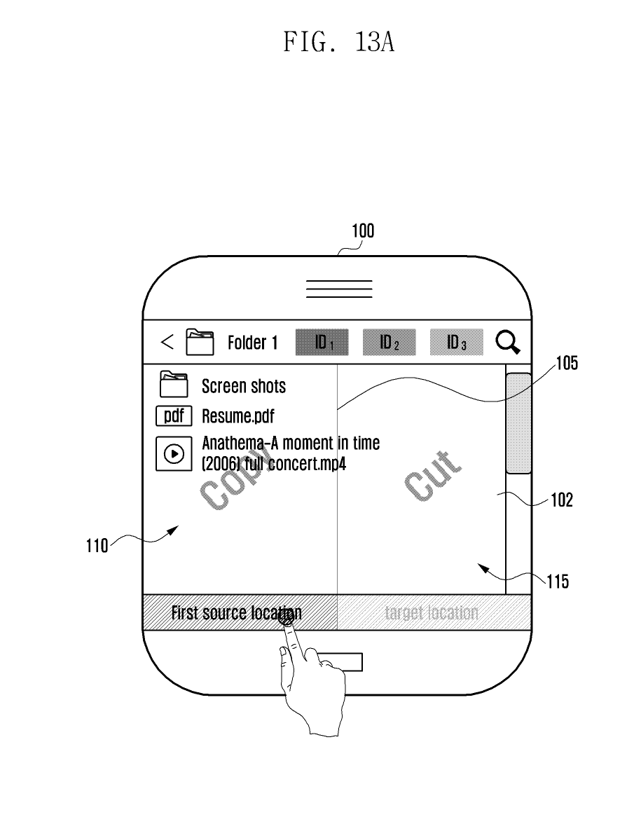

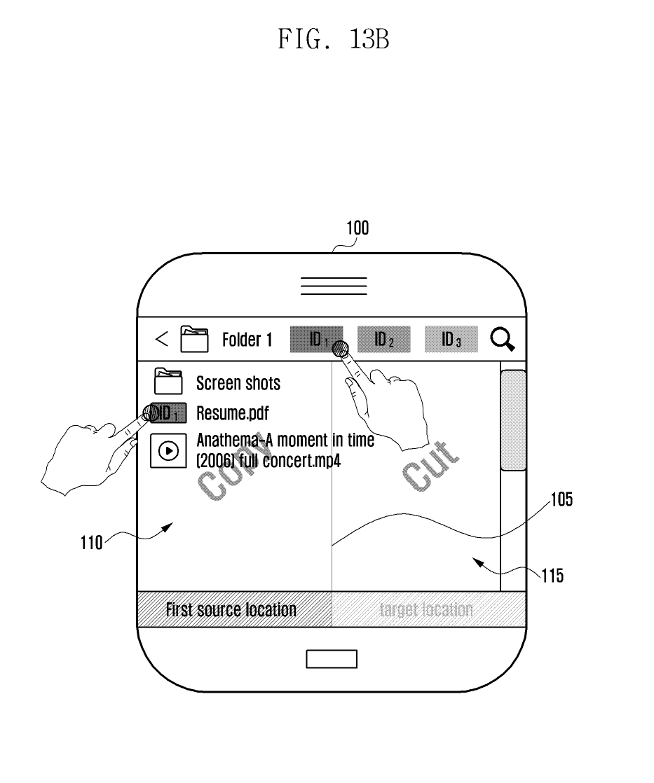

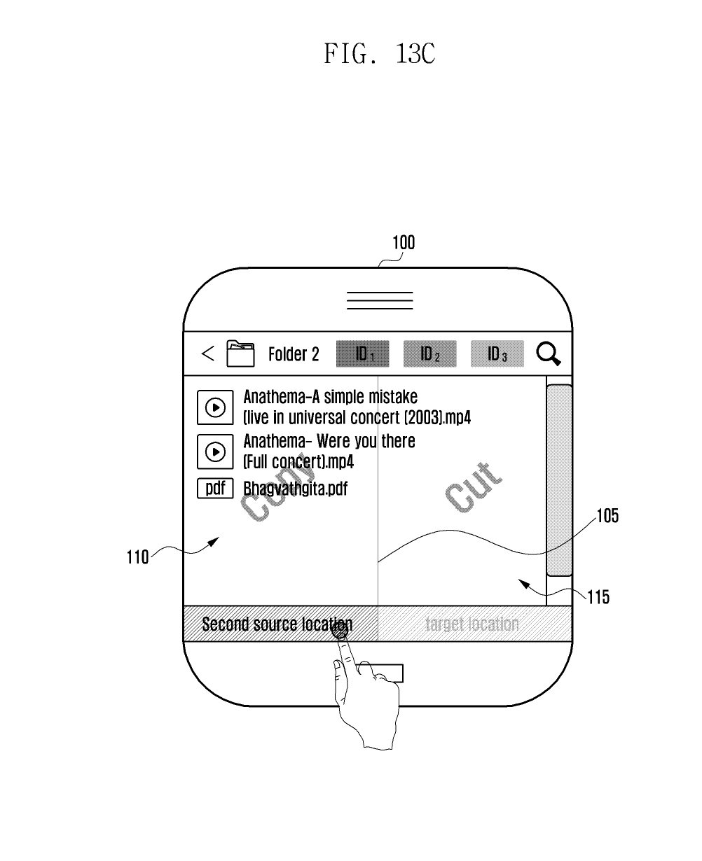

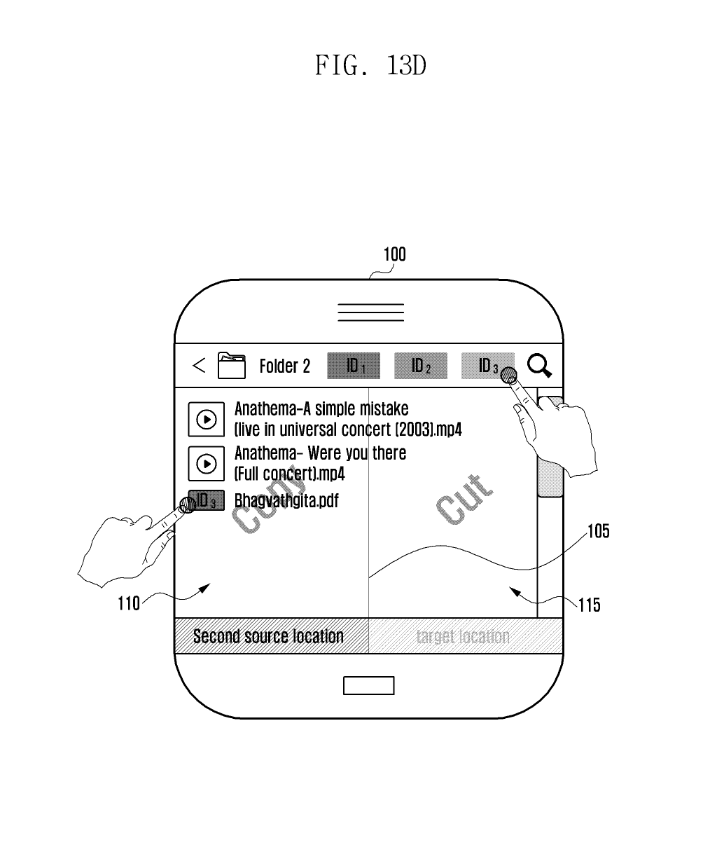

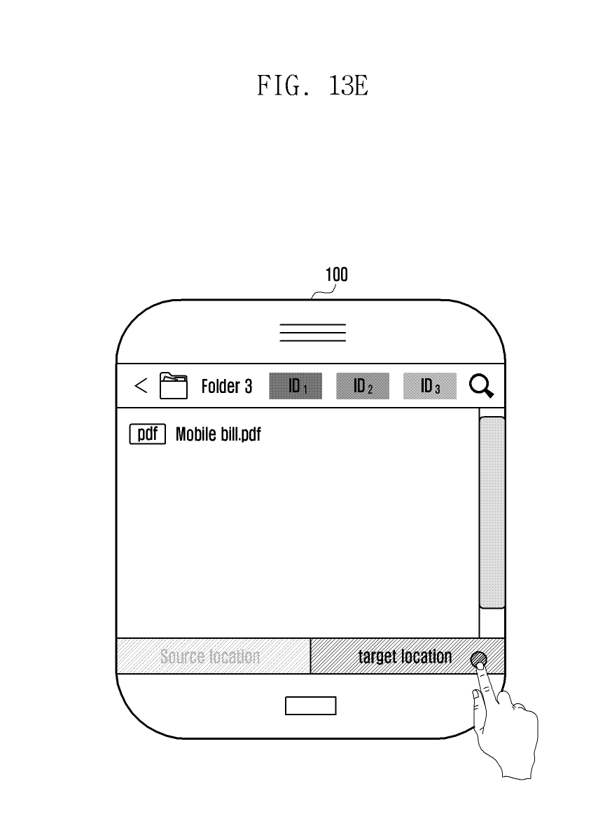

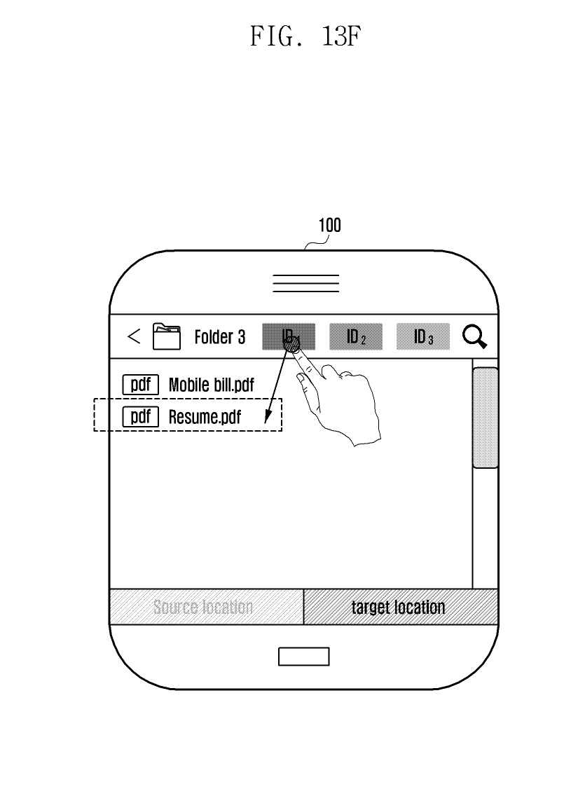

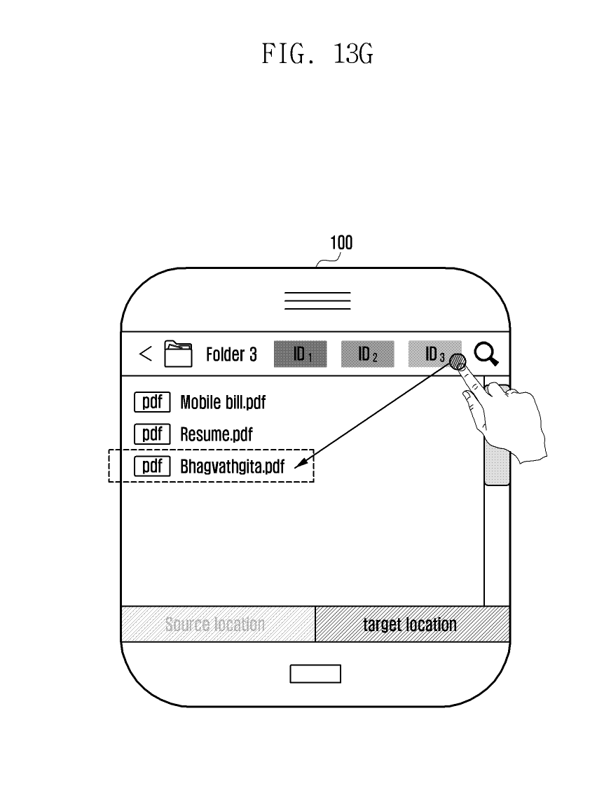

FIGS. 13A to 13G illustrate another example of transferring a first data item from a first source location and a second data item from a second source location to a target location in the electronic device, according to exemplary embodiments. Consider a scenario in which a user transfers the files from the source location to the target location. Initially, the user performs the gesture on the screen 102 of the electronic device 100 to initiate the transfer of the data items. After receiving the gesture from the user, the screen 102 for transferring the data items will be activated as shown in FIG. 13A.

Further, the screen 102 is vertically divided into two regions by a region line 105, where a first region 110 identifies a “COPY” function association and a second region 105 identifies a “CUT” function association as shown in FIG. 13A. Further, the screen 102 provides the user with the first identifier (id₁), the second identifier (id₂), and the third identifier (id₃) for associating the files with the “COPY” function or the “CUT” function. The screen 102 displays the list of files and the “Screen shot” folder of the folder “Folder 1”. The list of files includes the “Resume.pdf” file, the “Anathema—A moment in time (2006) full concert.mp4” file as shown in FIG. 13A.

Further, as shown in FIG. 13A, the user selects the folder “Folder 1” as the first source location and, as shown in FIG. 13B, performs a first action, e.g., performing a pattern of gestures performed on the first identifier id₁ followed by the “Resume.pdf” file in the “COPY” function region 110 on the screen 102 to associate the “Resume.pdf” file and the “COPY” function (e.g., first function) with the first identifier id₁. Further, as shown in FIG. 13C, the user selects the folder “Folder 2” as the second source location and, as shown in FIG. 13D, performs the second action, e.g., a pattern of gestures performed on the third identifier id₃ followed by the “Bhagvathgita.pdf” file in the “COPY” function region 110 on the screen 102 to associate the “Bhagvathgita.pdf” file and the “COPY” function (e.g., second function) with the third identifier id₃.

Further, the user selects the folder “Folder 3” as the target location as shown in FIG. 13E. As shown in FIG. 13F, the user performs a third action, e.g., a long press on the first identifier id₁ and a drag action performed in the target location, to perform the “COPY” function to transfer the “Resume.pdf” file from the folder “Folder 1” to the folder “Folder 3” (e.g., target location). As shown in FIG. 13G, the user performs a fourth action similar to the third action, e.g., a long press on the third identifier id₃ and a drag action performed in the target location to perform the “COPY” function to transfer the “Bhagvathgita.pdf” file from the folder “Folder 2” to the folder “Folder 3” (e.g., target location).

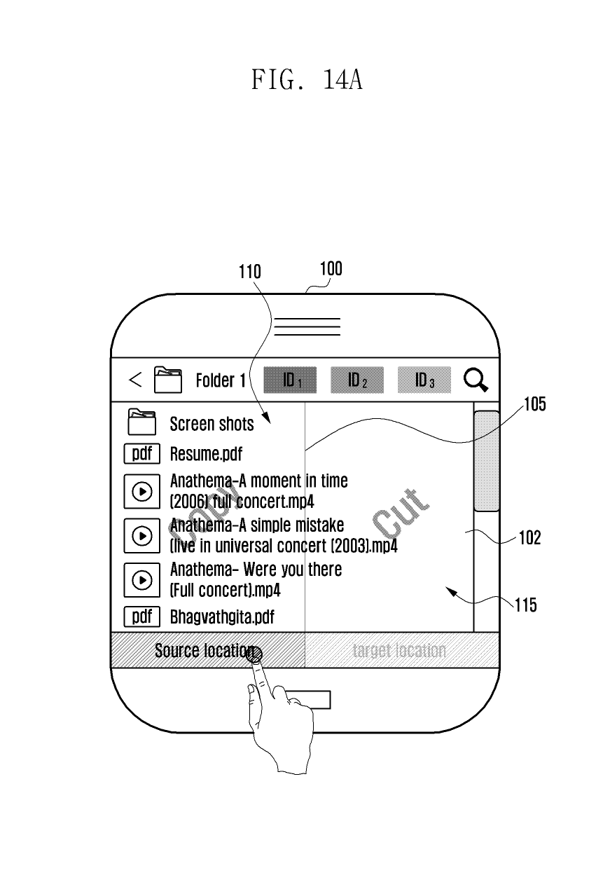

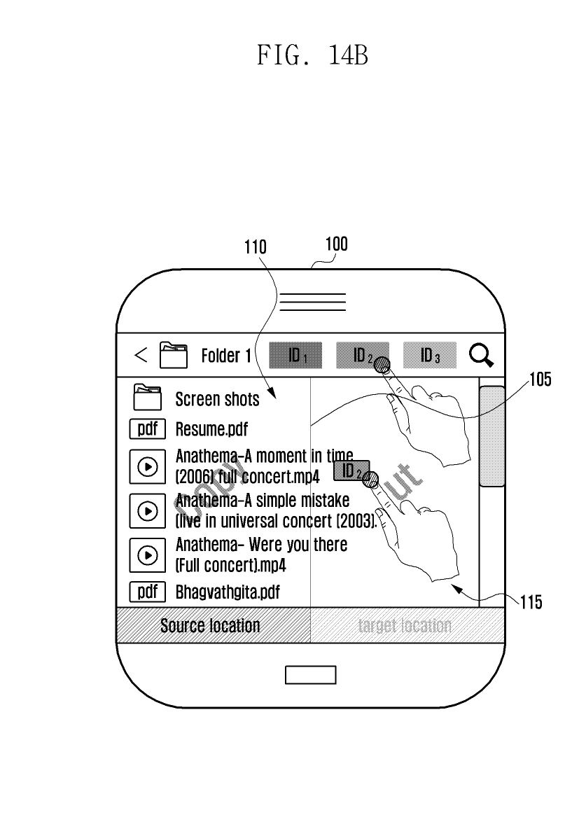

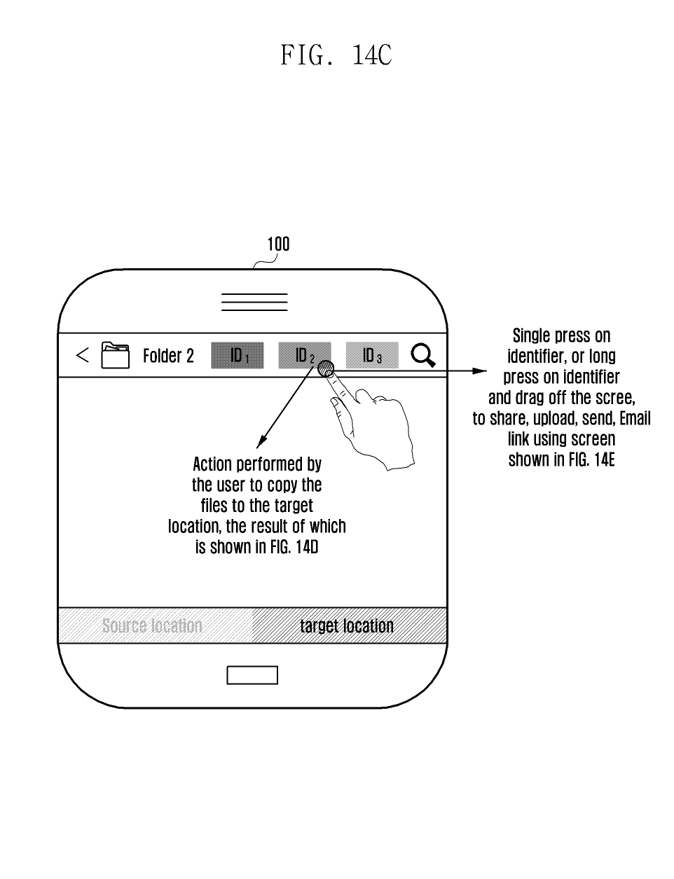

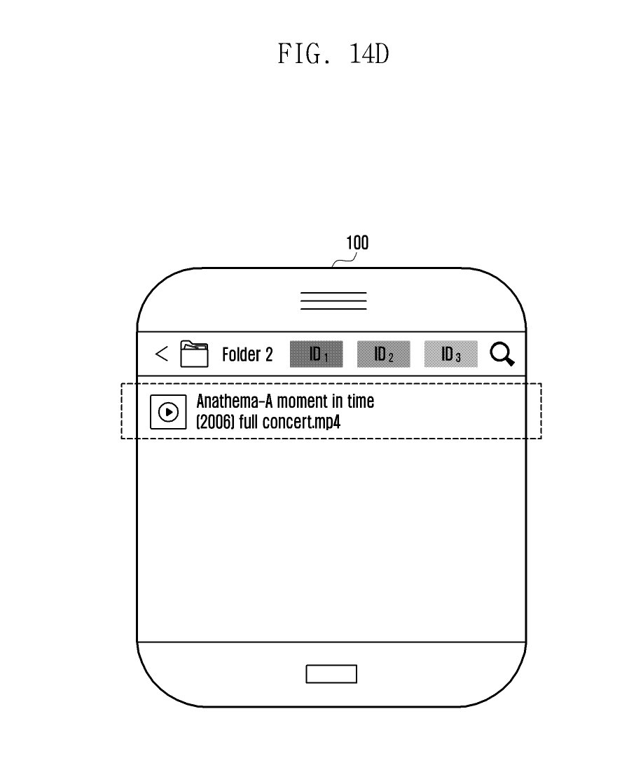

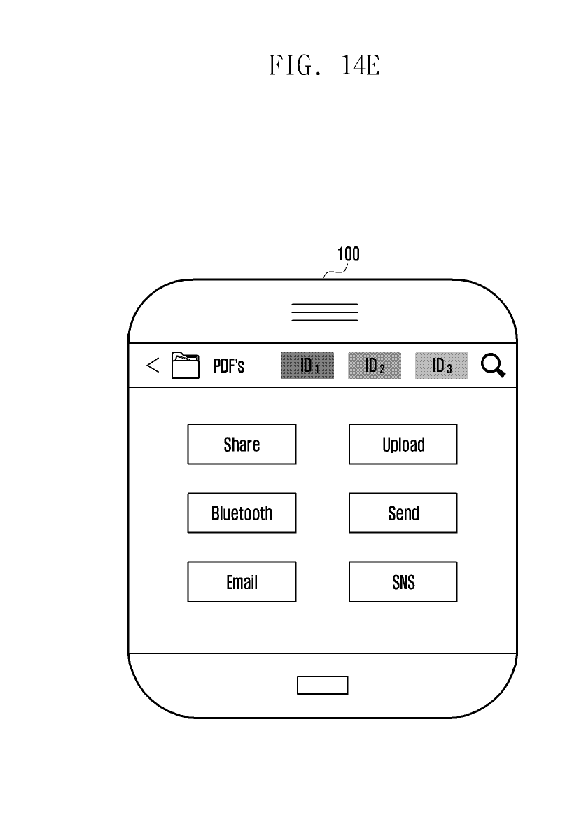

FIGS. 14A to 14E illustrate an example of transferring or sharing one or more data items in the electronic device 100, according to exemplary embodiments. The user selects the folder “Folder 1” as a source location by performing a gesture as shown in FIG. 14A. Further, as shown in FIG. 14B, the user performs a first action, e.g., a pattern of gestures performed on the second identifier id₂ followed by the “Anathema-A moment in time (2006) full concert.mp4” file in the “CUT” function region 115 on the screen 102 to associate the “Anathema-A moment in time (2006) full concert.mp4” file and the “CUT” function with the second identifier id₂.

Further, as shown in FIG. 14C, the user may have two different options depending on the gesture used. For example, the user may select the folder “Folder 2” as the target location, as described above, and perform a third action, e.g., a long press on the second identifier id₂ and a drag action performed in the target location to perform the “CUT” function to transfer the “Anathema-A moment in time (2006) full concert.mp4” file from the folder “Folder 1” to the folder “Folder 2” (e.g., target location) as discussed above, the result of which is shown in FIG. 14D. Alternatively, the user may perform a single press on the second identifier id₂, or may perform a long press on the second identifier id₂ and a drag off the screen to bring up a screen shown in FIG. 14E to share, upload, send, Email, link, or the like the “Anathema-A moment in time (2006) full concert.mp4 file”.

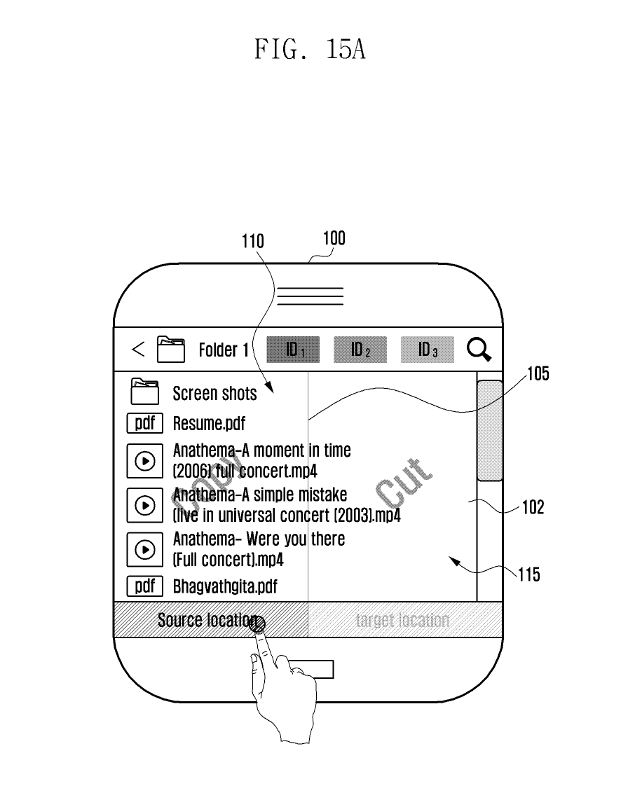

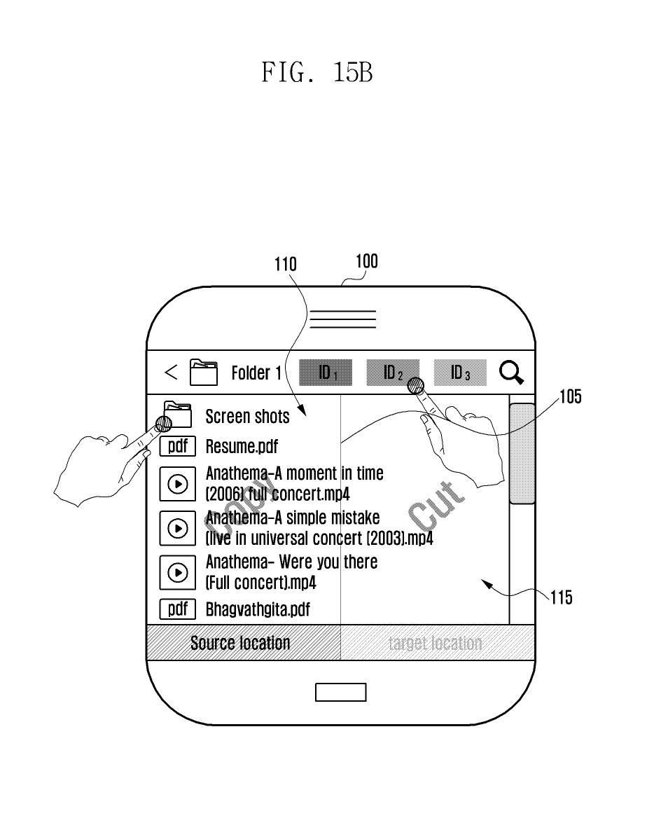

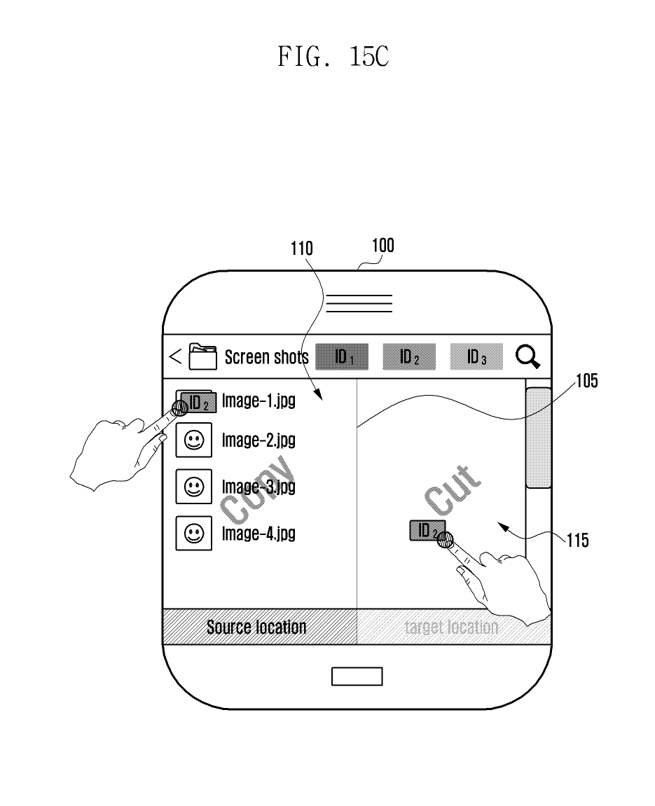

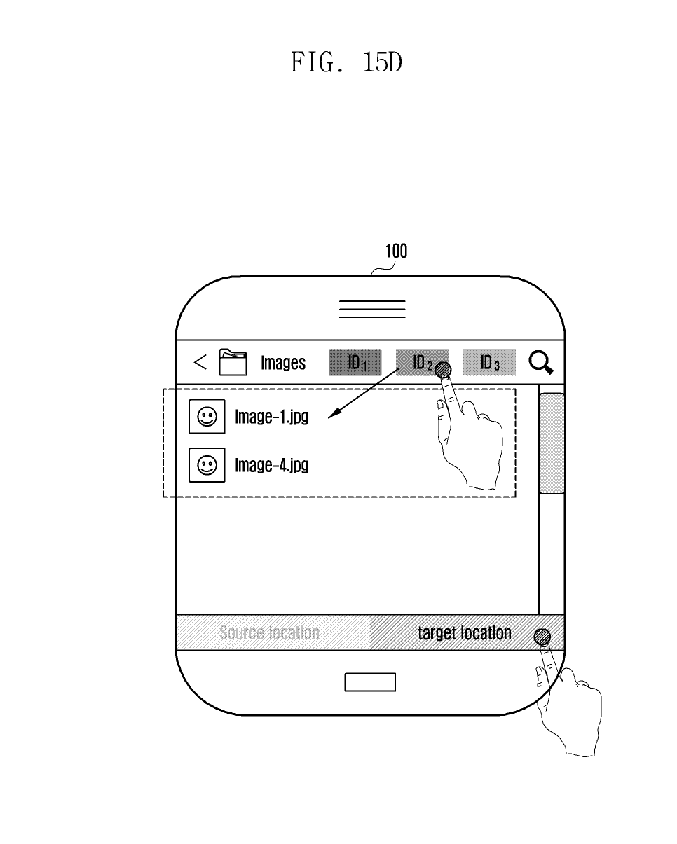

FIGS. 15A to 15D illustrate an example of transferring a first data item by performing a first function and a second data item by performing a second function from a source location to a target location in the electronic device 100, according to exemplary embodiments. The user selects the folder “Folder 1” as the source location by performing the gesture as shown in FIG. 15A.

Further, as shown in FIG. 15B, the user performs a first action, e.g., a pattern of gestures performed on the second identifier id₂ followed by the “Screen shot” folder, from which the user associates an “Image-1.jpg” file with the “COPY” function and an “Image-4.jpg” file with the “CUT” function as shown in FIG. 15C. Further, the user selects the “images” folder as the target location as shown in FIG. 15D. Further, the user performs an action, e.g., a long press on the second identifier id₂ and a drag action performed in the target location to perform the “COPY” function to transfer the “image-1.jpg” file and the “CUT” function to transfer the “image-4.jpg” file from the “Screen shot” folder to the “images” folder as shown in FIG. 15D.

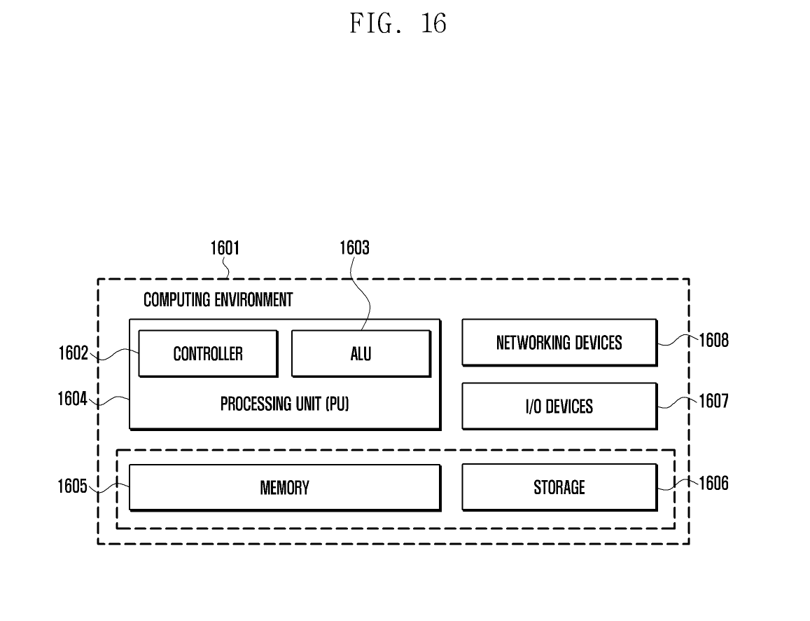

FIG. 16 illustrates a computing environment implementing the method and system for transferring one or more data items from a same source location or multiple source locations to a target location in the electronic device 100, according to exemplary embodiments. As depicted in FIG. 16, the computing environment 1601 may include at least one processing unit (PU) 1604 that is equipped with a controller 1602 and an Arithmetic Logic Unit (ALU) 1603, a memory 1605, a storage 1606, plurality of networking devices 1608 and a plurality Input output (I/O) devices 1607. The processing unit 1604 is responsible for processing the instructions of an algorithm. The processing unit 1604 receives commands from the controller in order to perform its processing. Further, any logical and arithmetic functions involved in the execution of the instructions are computed with the help of the ALU 1603. The processing unit (PU) 1604 may include one or more microprocessors.

The overall computing environment 1601 may be composed of multiple homogeneous and/or heterogeneous cores, multiple CPUs of different kinds, special media and other accelerators. The processing unit 1604 is responsible for processing the instructions of the algorithm. Further, the plurality of processing units 1604 may be located on a single chip or over multiple chips.

The algorithm including instructions and codes for the implementation of the above methods are stored in either the memory 1605 or the storage 1606 or both. At the time of execution, the instructions may be fetched from the corresponding memory 1605 and/or storage 1606, and executed by the processing unit 1604.

In case of any hardware implementations various networking devices 1608 or external I/O devices 1607 may be connected to the computing environment to support the implementation through the networking device and the I/O devices.

The exemplary embodiments disclosed herein may be implemented through at least one software program running on at least one hardware device and performing network management functions to control the elements. The elements shown in FIGS. 1 to 16 include blocks which may be at least one of a hardware device, or a combination of hardware device and software module.

The foregoing description of the specific exemplary embodiments will reveal the general nature of the exemplary embodiments herein that others may, by applying current knowledge, readily modify and/or adapt for various applications such specific exemplary embodiments without departing from the generic concept, and, therefore, such adaptations and modifications should and are intended to be comprehended within the meaning and range of equivalents of the disclosed exemplary embodiments. It is to be understood that the phraseology or terminology employed herein is for the purpose of description and not of limitation. Therefore, while the exemplary embodiments herein have been described in terms of exemplary embodiments, those skilled in the art will recognize that the exemplary embodiments herein may be practiced with modification within the spirit and scope of the exemplary embodiments as described herein.

What is claimed is:

1. A method for transferring data items in an electronic device, the method comprising:
associating a function and at least one data item with an identifier based on a user action performed in a source location; and
performing the function to transfer the at least one data item from the source location to a target location based on the user action performed on the identifier in the target location.

2. The method of claim 1, wherein the user action is performed in the source location and the target location, and
the user action comprises at least one of a pattern of gestures or a type of gesture to be performed on at least one of the identifier, the at least one data item and the function.

3. A method for transferring data items in an electronic device, the method comprising:
associating at least one data item with an identifier based on a user action performed by a user in a source location;
associating the identifier with a function based on the user action performed in a target location; and
performing the function to transfer the at least one data item from the source location to the target location.

4. The method of claim 3, wherein the user action is performed in the source location and the target location, and
the user action comprises at least one of a pattern of gestures or a type of gesture to be performed on at least one of the identifier, the at least one data item and the function.

5. A method for transferring data items in an electronic device, the method comprising:
associating a first data item and a first function with an identifier based on a user action performed by a user in a source location;
associating a second data item and a second function with the identifier based on the user action performed by the user in the source location; and
performing the first function and the second function to transfer the first data item and the second data item from the source location to a target location based on the user action performed on the identifier in the target location.

6. The method of claim 5, wherein the user action is performed in the source action and the target location, and
the user action comprises at least one of a pattern of gestures or a type of gesture to be performed on at least one of the identifier, the first data item, the second data item, the first function, and the second function.

7. A method for transferring data items in an electronic device, the method comprising:
associating a first data item and a first function with an identifier based on a user action performed by a user in a first source location;
associating a second data item and a second function with the identifier based on the user action performed by the user in a second source location; and
performing the first function and the second function to transfer the first data item from the first source location and the second data item from the second source location to a target location based on the user action performed on the identifier in the target location.

8. The method of claim 7, wherein the user action is performed in the first source location, the second source location and the target location, and
the user action comprises at least one of a pattern of gestures or a type of gesture to be performed on at least one of the identifier, the first function, the second function, the first data item and the second data item.

9. An electronic device for transferring data items, the electronic device comprising at least one microprocessor configured to:
associate a function and at least one data item with an identifier based on a user action performed in a source location; and
perform the function to transfer the at least one data item from the source location to a target location based on the user action performed on the identifier in the target location.

10. The electronic device 9, wherein the user action is performed in the source location and the target location, and
the user action comprises at least one of a pattern of gestures or a type of gesture to be performed on at least one of the identifier, the function and the at least one data item.

11. An electronic device for transferring data items, the electronic device comprising at least one microprocessor configured to:
associate at least one data item with an identifier based on a user action performed by a user in a source location;
associate the identifier with a function based on the user action performed in a target location; and
perform the function to transfer the first data item from the source location to the target location.

12. The electronic device of claim 11, wherein the user action is performed in the source location and the target location, and
the user action comprises at least one of a pattern of gestures or a type of gesture to be performed on at least one of the identifier, the function and the at least one data item.

13. An electronic device for transferring data items, the electronic device comprising at least one microprocessor configured to:
associate a first data item and a first function with an identifier based on a user action performed in a source location;
associate a second data item and a second function with the identifier based on the user action performed in the source location; and
perform the first function and the second function to transfer the first data item and the second data item from the source location to a target location based on the user action performed on the identifier in the target location.

14. The electronic device of claim 13, wherein the user action is performed in the first source location, the second source location and the target location, and
the user action comprises at least one of a pattern of gestures or a type of gesture to be performed on at least one of the identifier, the first function, the second function, the first data item and the second data item.

15. An electronic device for transferring data items, the electronic device comprising at least one microprocessor configured to:
associate a first data item and a first function with an identifier based on a user action performed in a first source location;
associate a second data item and a second function with the identifier based on the user action performed in a second source location; and
perform the first function and the second function to transfer the first data item from the first source location and the second data item from the second source location to a target location based on the user action performed on the identifier in the target location.

16. The electronic device of claim 15, wherein the user action is performed in the first source location, the second source location and the target location, and
the user action comprises at least one of a pattern of gestures or a type of gesture to be performed on at least one of the identifier, the first function, the second function, the first data item and the second data item.

17. A computer program product comprising computer executable program code recorded on a computer readable non-transitory storage medium, wherein the computer executable program code when executed by a computer causes functions including:
associating a function and at least one data item with an identifier based on a user action performed by a user in a source location; and
performing the function to transfer the at least one data item from the source location to a target location based on the user action performed on the identifier in the target location.

18. A computer program product comprising computer executable program code recorded on a computer readable non-transitory storage medium, wherein the computer executable program code when executed by a computer causes functions including:
associating at least one data item with an identifier based on a user action performed by a user in a source location;
associating the identifier with a function based on the user action performed in a target location; and
performing the function to transfer the first data item from the source location to the target location.

19. A computer program product comprising computer executable program code recorded on a computer readable non-transitory storage medium, wherein the computer executable program code when executed by a computer causes functions including:
associating a first data item and a first function with an identifier based on a user action performed by a user in a source location;
associating a second data item and a second function with the identifier based on the user action performed in the source location; and
performing the first function and the second function to transfer the first data item and the second data item from the source location to a target location based on the user action performed on the identifier in the target location.

20. A computer program product comprising computer executable program code recorded on a computer readable non-transitory storage medium, wherein the computer executable program code when executed by a computer causes functions including:
associating a first data item and a first function with an identifier based on a user action performed by a user in a first source location;
associating a second data item and a second function with the identifier based on the user action performed in a second source location; and
performing the first function and the second function to transfer the first data item from the first source location and the second data item from the second source location to a target location based on the user action performed on the identifier in the target location.
